(19) United States
(12) Patent Application Publication
(10) Pub. No.: US 2005/0101169 A1
(43) Pub. Date: May 12, 2005

(54) Locking connector

(76) Inventor: Anthony Brotherton Ratcliffe, Ripe (GB)

Correspondence Address: STITES & HARBISON PLLC, 1199 NORTH FAIRFAX STREET, SUITE 900, ALEXANDRIA, VA, 22314, US

(21) Appl. No.: 10/499,334

(22) PCT Filed: Dec. 17, 2002
(86) PCT No.: PCT/GB02/05714

(30) Foreign Application Priority Data
Dec. 17, 2001 (GB) 0130126.6

(51) Int. Cl. H01R 4/66

(52) U.S. Cl. 439/106

(57) ABSTRACT

A connector is described wherein the connector comprises a socket for receiving a plug having a plurality of pins wherein the socket presents a greater resistance to withdrawal of at least one pin than insertion of the pin. Preferably, removal of the pin is substantially prevented except by means of a release mechanism which may optionally be provided.

The invention relates to the field of connectors and, more particularly, to connectors used between items of electrical equipment, or used to connect electrical equipment to a power supply.

Some prior art systems have been designed to reduce the ease with which plugs may be removed from (or may fall out of) sockets in electrical equipment. A known solution, used commonly in computer equipment, is for screws or clips at either side of the plug to keep the plug attached to the equipment to which it is connected. Screwing or clipping the plug to the equipment, however, is labourious and it is possible to unscrew or unclip the connector and release it from the equipment.

In many situations, it may be desirable to lock individual pieces of equipment together more permanently than the prior art solutions allow. It may also be desirable for the locking mechanism to be simple and fast to operate. The invention aims to provide an improved locking connector, with a locking mechanism that may be operated quickly and easily.

Aspects of the invention are set out in the claims and preferred features are set out in the dependent claims to which reference should be made. Preferred features of each aspect may be applied to other aspects unless otherwise expressly stated.

According to a first aspect, the invention provides a connector comprising a socket for receiving a plug having a plurality of pins wherein the socket presents a greater resistance to withdrawal of at least one pin than to insertion of the pin. This is advantageous since a locking connector that operates by requiring a greater force to remove a pin than to insert a pin may provide a mechanism that is easy and fast to operate, but which may be effective in locking the plug into the connector.

A further significant advantage of at least preferred embodiments is also provided by the fact that no changes are required to the pin to facilitate operation of the locking connector. Hence the connector can be used on existing pins and on standard connectors, allowing the connector to have a wide range of applications without requiring modification of existing equipment.

Preferably, removal of the pin from the connector is substantially prevented. This may allow permanent connection of the plug to the connector socket.

Preferably, the connector further comprises a moveable member which is displaced by insertion of the pin to permit insertion of the pin, but which seizes the pin on attempted withdrawal. An advantage of such a moveable member may be that it allows easy insertion of the pin into the connector whilst it may also prevent removal of the pin from the connector.

More preferably, the moveable member comprises a plate having a hole through which the pin is inserted. The hole in the moveable member may form part of the mechanism by which the pin is retained in the connector.

More preferably, the dimensions of the hole in the plate are substantially the same as those of a cross section of a portion of the pin. This may mean that, if the plate is substantially perpendicular to the direction of insertion of the pin, the pin may be freely inserted but, when the plate is angled with respect to the direction of elongation of the pin, the plate seizes the pin. Preferably the plate is biased (preferably resiliently) towards an angled position. This may assist the retaining mechanism in operating as soon as forces are applied to the pin to remove it from the connector.

Preferably, at least one edge of the hole in the moveable member engages and retains the pin by frictional forces. This may provide a simple but effective mechanism by which the pin may be retained in the socket. Preferably the front of the plate has a first angular edge at one side of the hole and the back of the plate has a second edge at the opposite side of the hole, the first and second edges being arranged to bite into the pin when the plate is angled. The edges are preferably angular, for example substantially square corners. The plate is preferably at least 0.5 mm thick, more preferably at least 1 mm thick.

Preferably, the biased moveable member (when biased in the absence of a pin) makes an angle of between about 10 degrees and about 20 degrees with the front face of the connector, more preferably about 14 to 18 degrees. An angle of around 16 degrees is found to be particularly advantageous in allowing easy insertion of the pin whilst also allowing the moveable member to engage the pin and retain it in the connector.

Preferably, the edges of the hole in the moveable member are processed or hardened, for example by grinding, to produce substantially sharp edges. The steel may further be finished by barrelling on a zinc coating. Producing sharp edges to the hole in the moveable member may allow the pin to be held more securely within the connector. However, if the connector has a large spring force, discussed below, non-hardened or sharpened edges may suffice and this may present resistance with minimal damage to a pin.

According to a further embodiment, the moveable member may be laser-cut from mild steel with case hardening.

Preferably, the biased moveable member is arranged to move away from its biased position on insertion of the pin. This may allow the edges of the hole in the pin to engage the pin whilst it is inserted into the connector and so provide resistance to removal of the pin as soon as a force is applied to remove the pin.

Preferably, the biasing means comprises a spring. The strength of the spring may be selected according to the purpose of the locking connector.

Preferably, the spring is a coil spring. In an alternative preferred implementation, the spring is a leaf spring.

Preferably, the spring applies a torque to the biased moveable member by bearing on one face of the member on or adjacent one side of the hole, the member being restrained (or biased by another spring) by means bearing on the opposite face on or adjacent the opposite side of the hole. The spring may bear directly or via a shaft, the shaft preferably being coupled to the biased moveable member via an arrangement which permits pivoting. This may provide a simple but effective mechanism by which the linear force produced by the spring may be translated effectively into a torsional force on the biased moveable member.

According to an alternative embodiment, the resistance to withdrawal of the pin may be provided by a plurality of moveable members, for example rollers, in a tapered or cammed cavity in an analogous manner to a roller clutch, wherein insertion of the pin moves the members to a relatively open section but withdrawal draws the members into a relatively confined section in which they grip the pin. As described in more detail below, the rollers allow easy insertion of the pin but lock on attempted removal of the pin from the connector. Frictional forces between the rollers and the pin may then substantially prevent removal of the pin.

Preferably, the connector further comprises means for releasing the pin from the retaining mechanism. It may be advantageous to allow removal of the pin from the locking connector. The ease with which the means for releasing the pin operates may vary according to the application for which the locking connector is used.

More preferably, the means for releasing said pin comprises a mechanism to reduce the magnitude of the forces applied to the pin by the moveable member. This may allow removal of the pin without damaging the locking mechanism of the connector. The release means may comprise means for applying a force to counteract the biasing force. The release means may include a depressable button but more preferably comprises a recess into which a tool, such as a small screwdriver, can be inserted to apply a force.

Preferably, the means for releasing the pin comprises a sliding bar for releasing the pin by applying a force to counteract the biasing force. The sliding bar mechanism may be operable from the outside of the housing when the connector is in use, hence allowing the connector to be released. This may allow the selective removal of connectors which are used to stop leads being removed from equipment accidentally, for example by vibration.

According to a preferred embodiment, the means for releasing the pin is not accessible during normal use. For example, it may be possible to operate the release mechanism via access means on or adjacent to the front face of the locking connector. Hence a user is prevented from operating the release mechanism once the connector has been attached to the pins. The release mechanism, which is normally concealed, may be used during manufacture or testing of the connectors in which a test rig may be used to ensure that the connector is operating effectively. The test rig is preferably designed to allow access to the release mechanism.

More preferably, the means for releasing the pin further comprises means to indicate whether the release mechanism has been used. This may allow those who installed the pin into the locking connector to monitor whether the pin has been released since its installation. The indication means may take the form, for example, of a tab or a seal that must be removed before the pin may be released.

Preferably, the indication means comprises a cover removably attached over the release means. The cover is preferably a transparent plastic cover which may be removed from the connector by snapping the cover away from the body of the connector. Hence the cover cannot be replaced once it has been removed and it is immediately apparent to a user that the release means has been accessed. The release means may be brightly coloured, for example coloured red, so that it is clearly visible through the cover. According to a preferable embodiment, the cover may be removed by applying a torsional force to an object e.g. a coin or screwdriver inserted into an indentation in the cover.

According to a highly preferable embodiment, the connector has both means for releasing the pin during testing, wherein the means is accessible on or adjacent to the front face of the connector, and means for releasing the pin accessible via a removable cover. Hence the connector may be tested during manufacture and released using the test release means without requiring access to the covered release means. Using this embodiment, the removable cover may remain intact during manufacture and testing whilst still allowing the connector to be tested.

Preferably, the connector further comprises means for providing an electrical connection to the pin, the pin being capable of carrying a current between the plug and the socket. This may allow the pin to be a functional pin which may be electrically connected to a power or signal line or to earth as well as securing the plug and socket.

Preferably, the pin is the earth pin of a plug. This may be advantageous since it allows the locking mechanism to operate on any standard plug, without requiring modification to the plug such as, for example, the addition of an extra pin for the locking connector to operate upon. A further advantage of this feature is that it may allow the mechanism to operate or be released safely without requiring disconnection from a live electricity supply.

Preferably, the connector is arranged such that the locking components of the connector are electrically isolated from the live electrical supply components.

In an embodiment, means may be provided for applying a retaining force to more than one of a plurality of pins in a single plug. This may allow the plug to be held more securely and may inhibit unauthorised release. This may be applicable in the case of a multi-pin connector where an individual plug may not necessarily have a pin to be inserted into every available hole in a connector.

A further preferable feature is that the connector is incorporated into a IEC (or “kettle-plug”) socket. This is advantageous, since an IEC specification connector can be used in a wide range of electrical devices without modification to those devices.

A second aspect provides a device for supplying controlled power to a further device, the device being provided with a connector according to the first aspect or any of its preferable features for connecting to the further device. Since the connector would allow the further device to be locked into the power supply, this may ensure a more secure connection to a power supply. The power supply for the further device could also be controlled independently, for example by the power supply device, which may allow use of the further device to be controlled.

A further aspect provides a test rig comprising a connector according to the first aspect of any of its preferable features and a complementary connector comprising means for releasing the pin from the connector.

Preferably, the complementary connector is arranged to release the pin from the connector by operating a test release mechanism on or adjacent to the front face of the connector. According to one embodiment, the complementary connector comprises a pin arranged to operate the test release mechanism by pushing on the slide piece of the connector via an access hole in the front face of the connector.

Embodiments of the invention will now be described with reference to the drawings which show non-limiting embodiments of the invention. Any dimensions or angles indicated in the drawings are exemplary and are not intended to be limiting. Alternative embodiments may provide connectors with different dimensions or a different arrangement of the locking mechanism. Aspects of the invention are set out in the claims.

Embodiments are illustrated in the drawings in which:

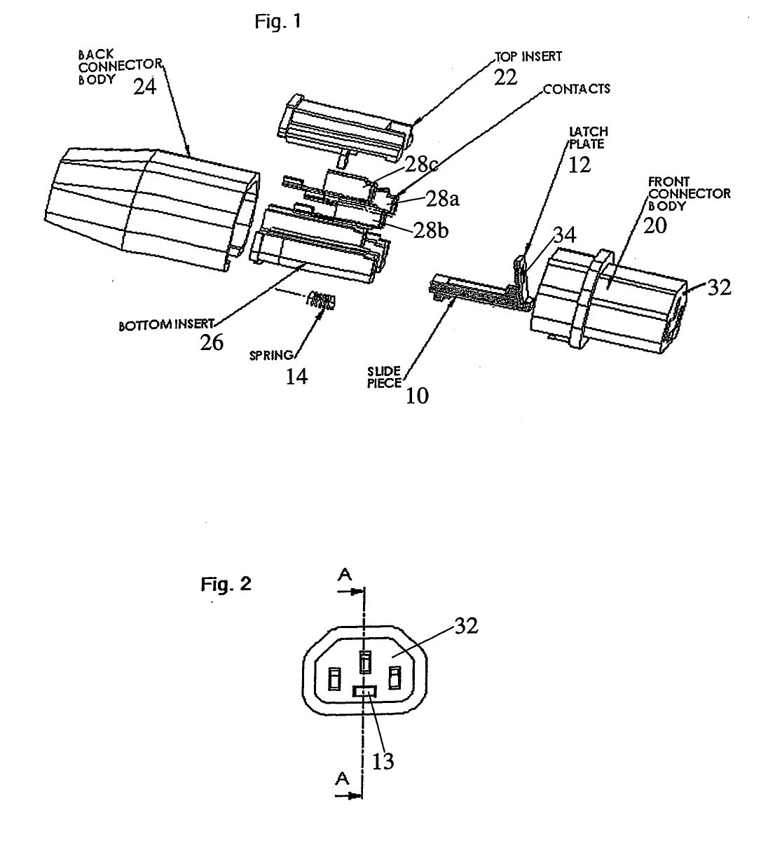

FIG. 1 is a schematic expanded view of the components of one embodiment of the locking connector.

FIG. 2 shows a view of the front face of the locking connector.

FIG. 3 is a schematic overview of a section through the line A-A in FIG. 2 with a pin inserted into the connector.

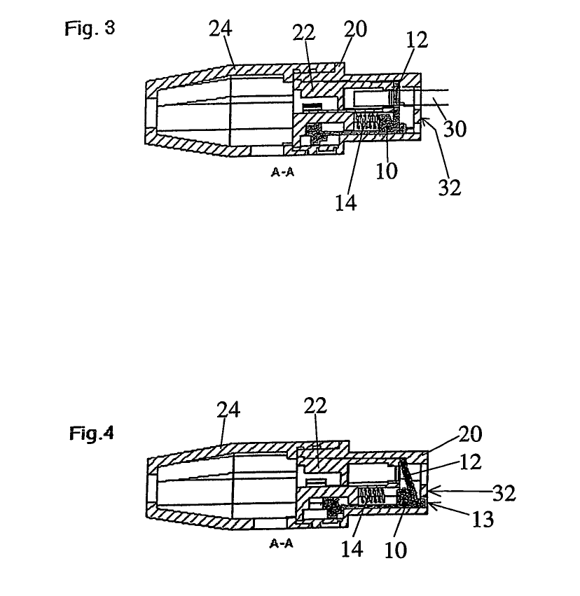

FIG. 4 is a schematic overview of a section through the line A-A in FIG. 2 without a pin inserted into the connector.

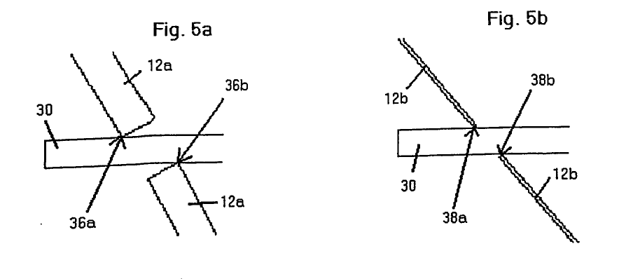

FIG. 5a is a side view of a pin inserted into the latch plate of a connector wherein the latch plate is thick.

FIG. 5b is a side view of a pin inserted into the latch plate of a connector wherein the latch plate is thin;

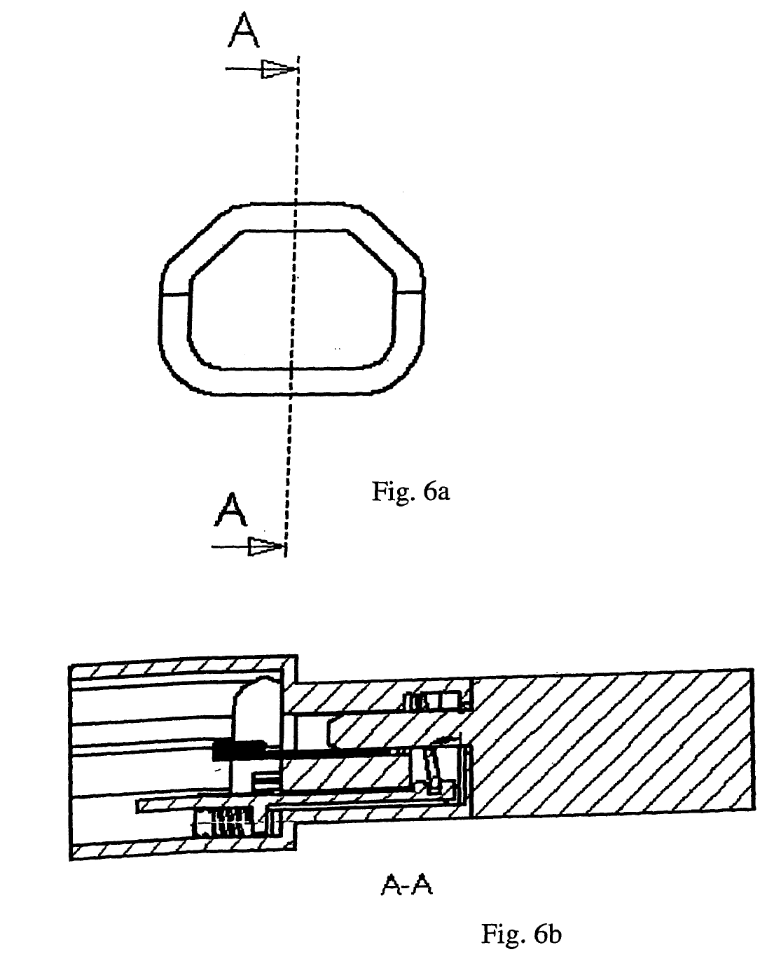

FIGS. 6a and 6b are schematic diagrams of a further embodiment of the locking connector;

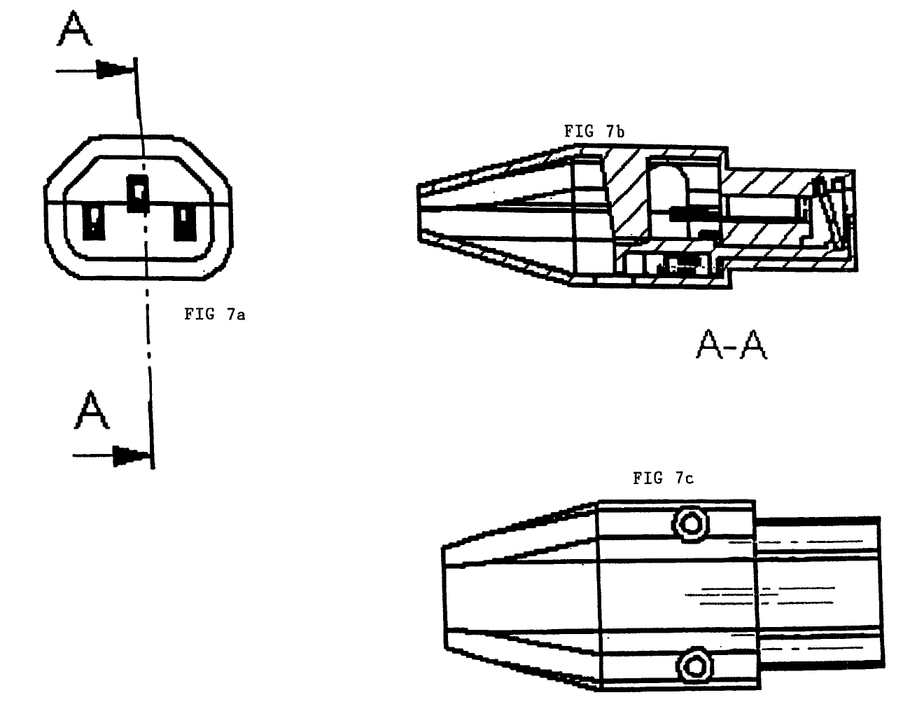

FIGS. 7a, 7b and 7c are schematic diagrams of a further embodiment of the locking connector wherein the housing is manufactured in two sections;

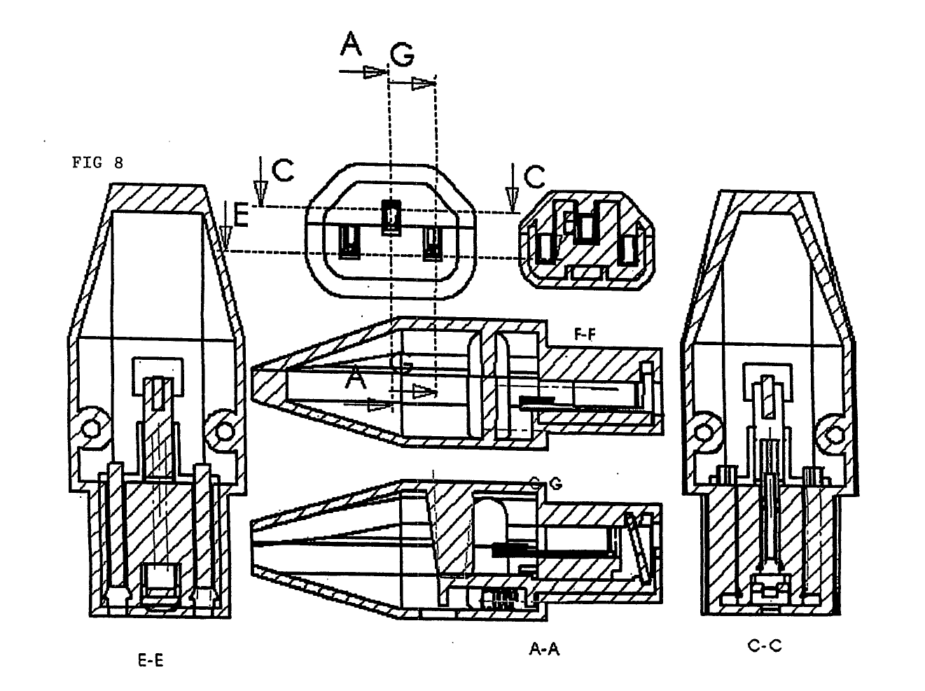

FIG. 8 shows a number of views of a further embodiment of the connector;

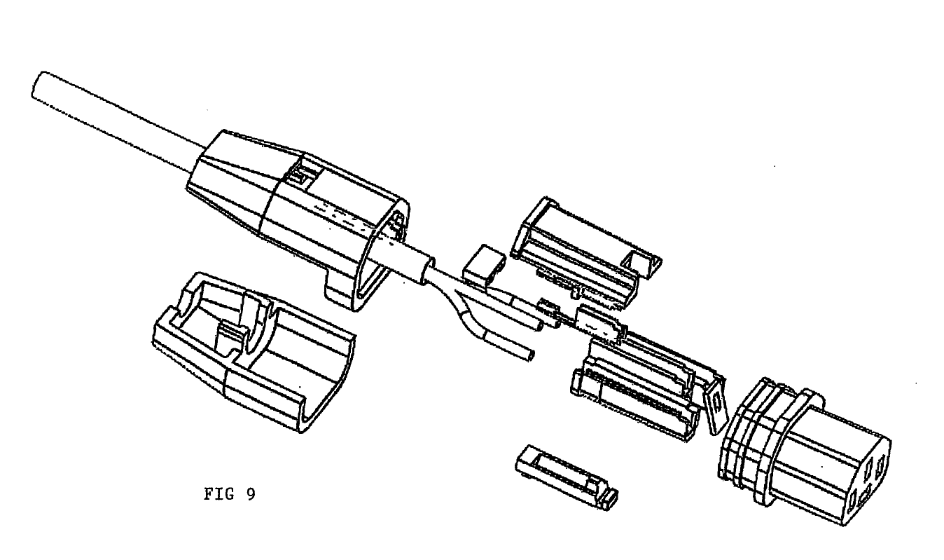

FIG. 9 is a schematic expanded diagram of one embodiment of the connector described herein;

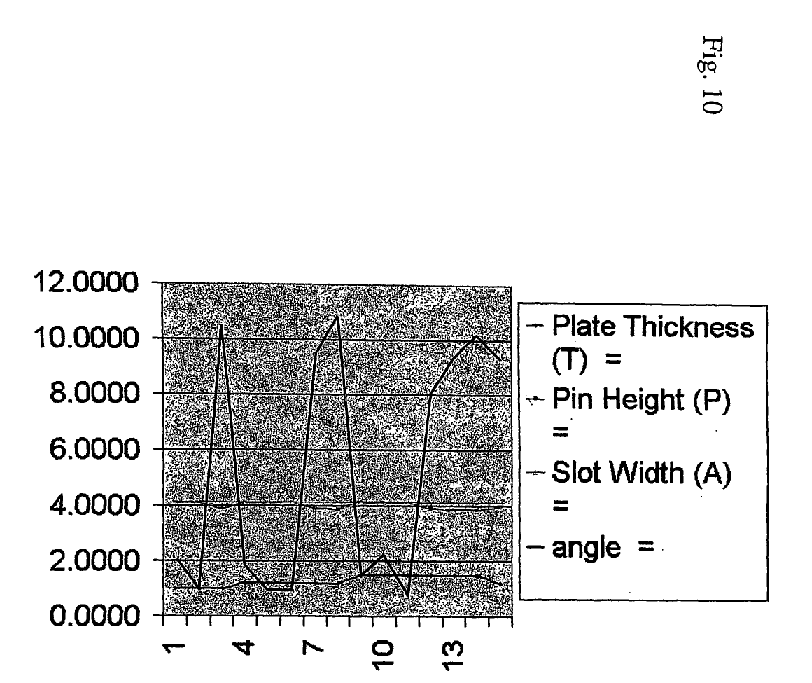

FIG. 10 is an illustration of how the optimum angle may vary with factors such as the plate thickness, pin height and slot width;

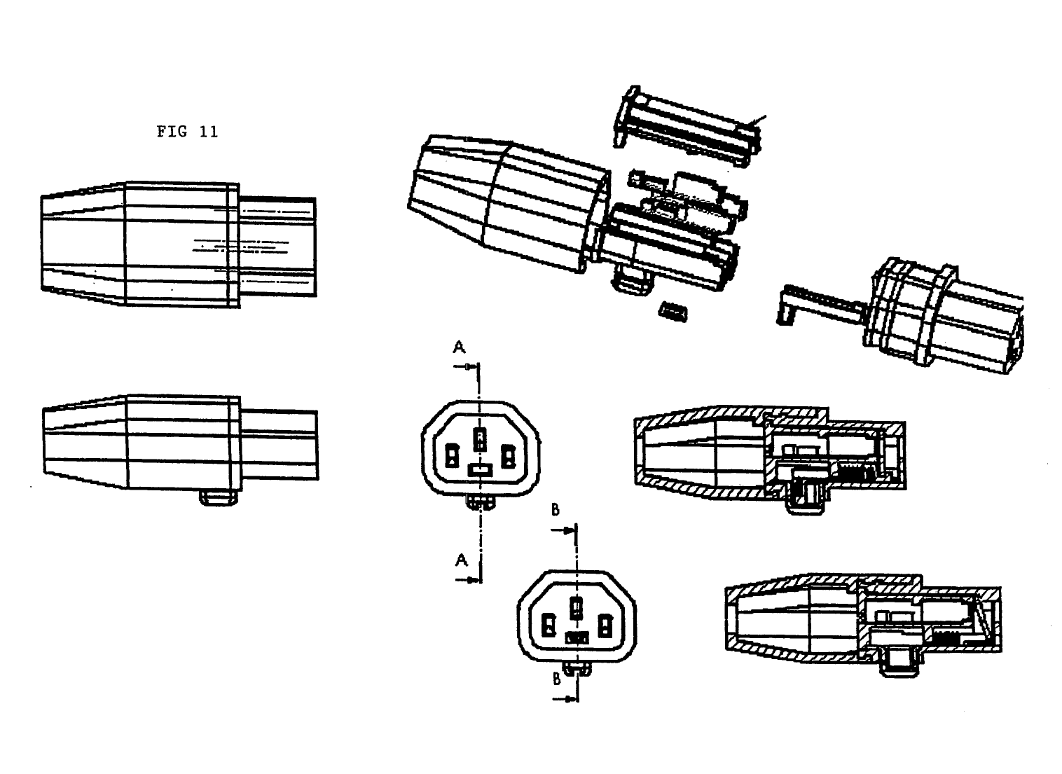

FIG. 11 shows a number of schematic views of one embodiment of the locking connector;

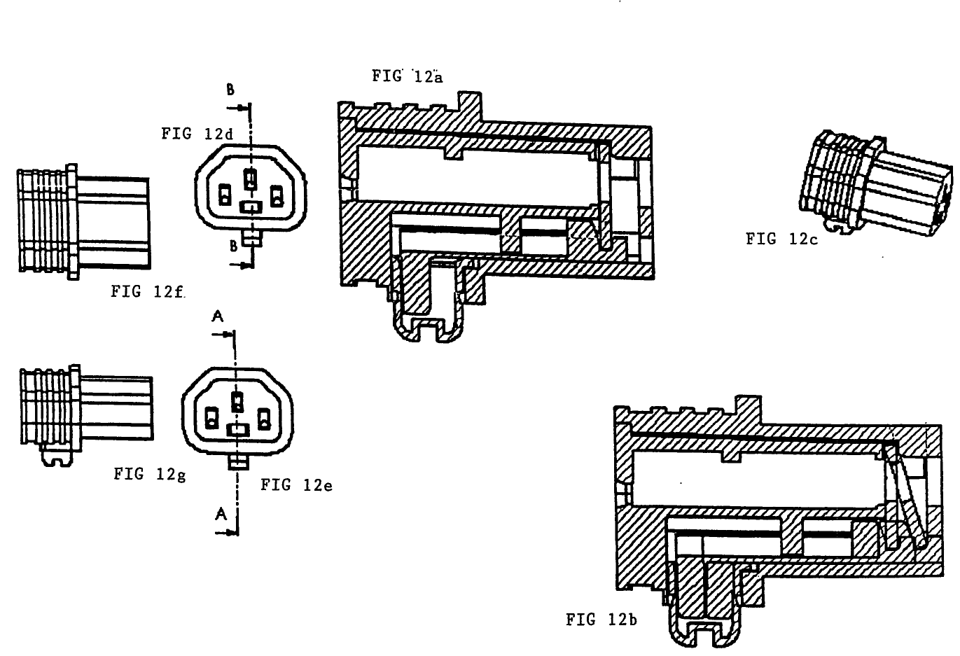

FIG. 12a is a schematic diagram of a further embodiment of the locking connector showing the latch plate in the upright position;

FIG. 12b is a schematic diagram of the locking connector of FIG. 12a showing the latch plate in both the upright and the biased positions;

FIGS. 12c to 12g are further views of the embodiment of the locking connector shown in FIGS. 12a and 12b;

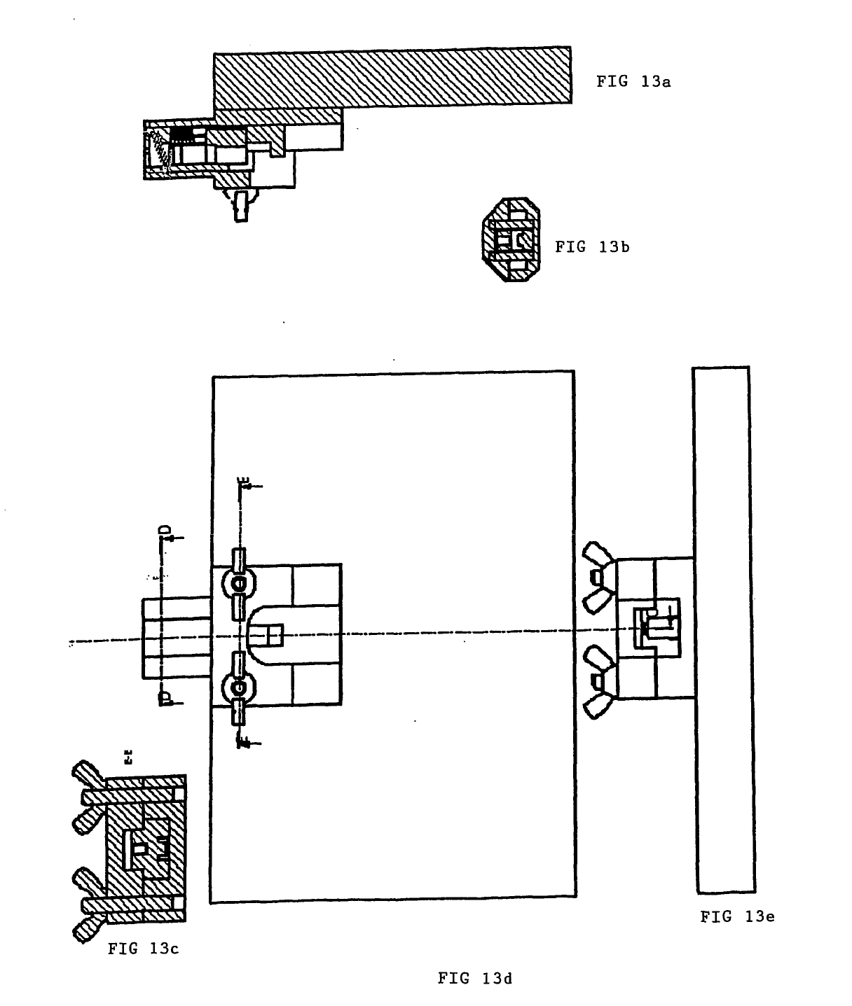

FIG. 13a is a schematic diagram of a side view of one embodiment of a locking connector test rig;

FIG. 13b is a schematic diagram of a front view of one embodiment of a locking connector test rig;

FIG. 13c is a schematic diagram of a top view of one embodiment of a locking connector test rig;

FIGS. 13d and 13e are further views of the locking connector test rig shown in FIGS. 13a to 13c;

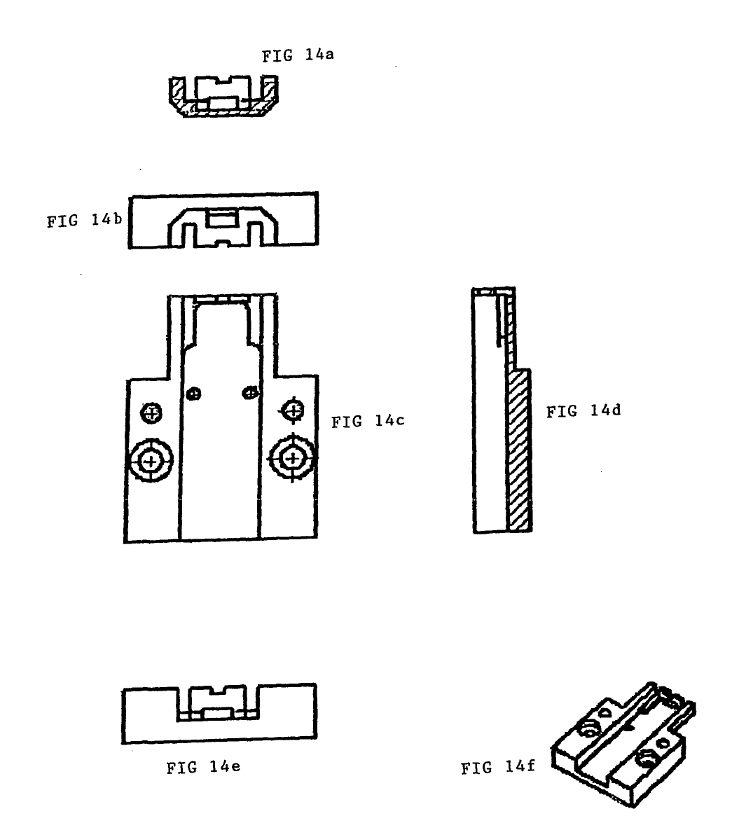

FIGS. 14a to 14f are views of a further embodiment of a locking connector test rig;

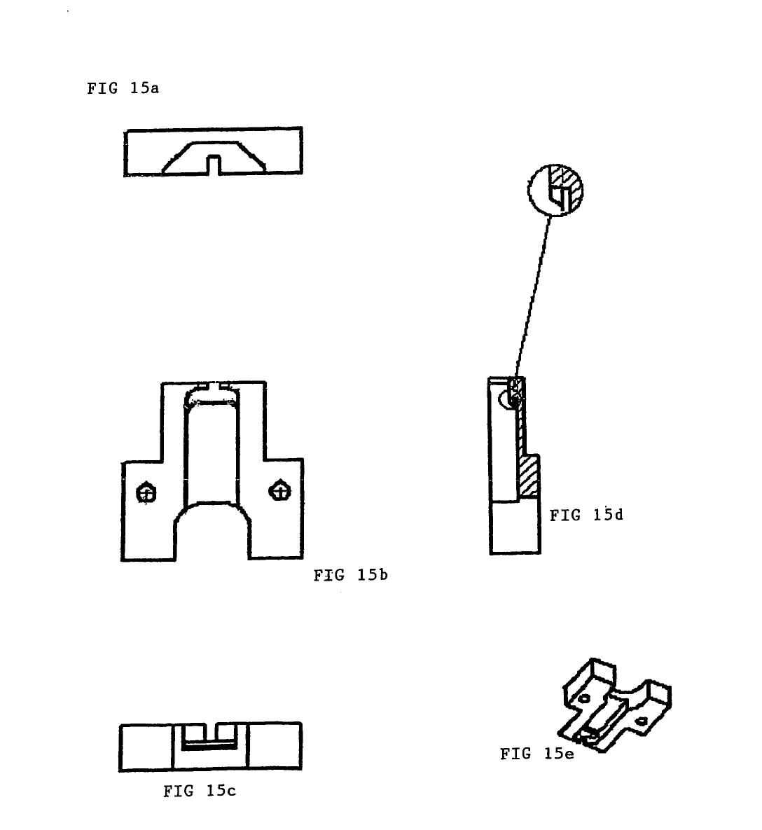

FIGS. 15a to 15e are views of components of a further embodiment of a locking connector test rig;

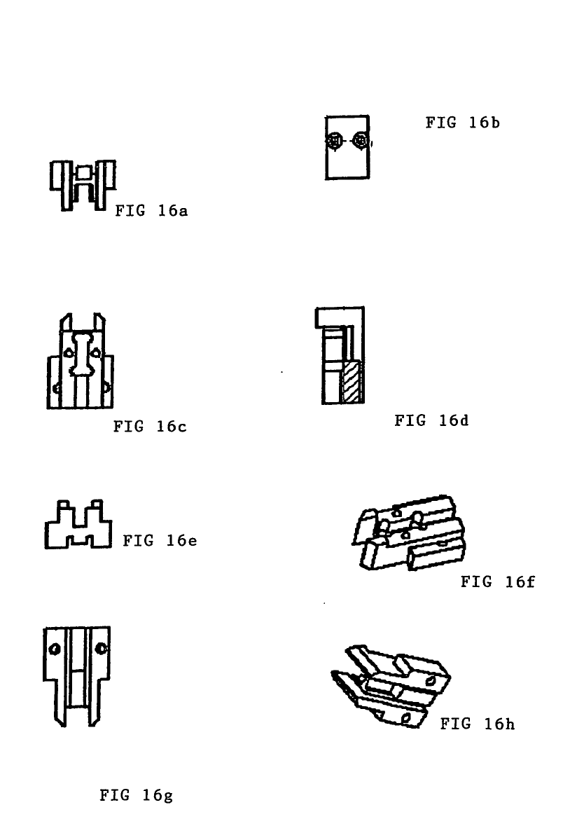

FIGS. 16a to 16h are views of components of a further embodiment of a locking connector test rig;

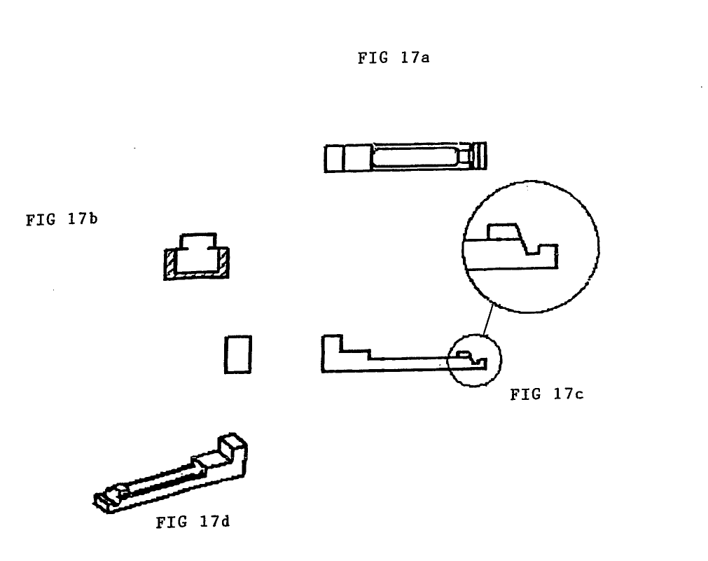

FIGS. 17a to 17d are views of components of a further embodiment of a locking connector test rig;

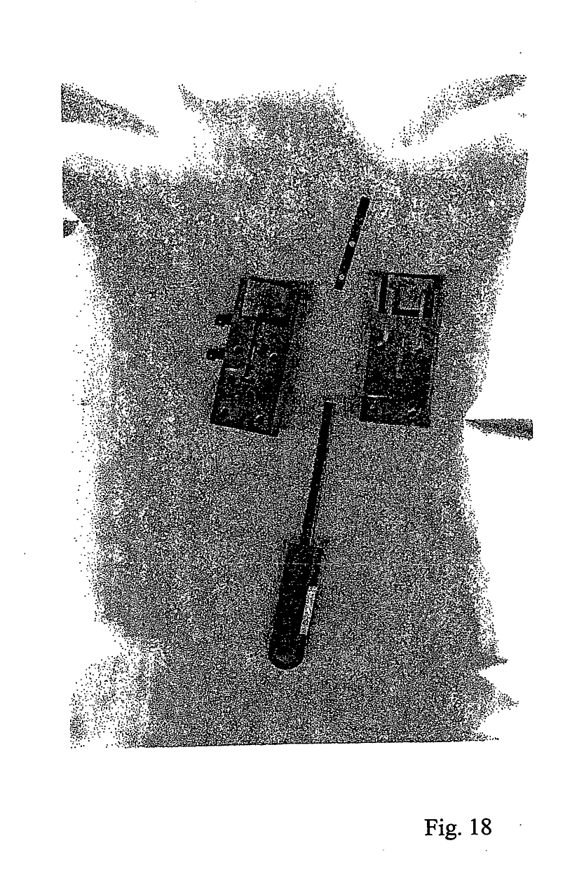

FIG. 18 is an illustration of some of the components of a locking connector test rig;

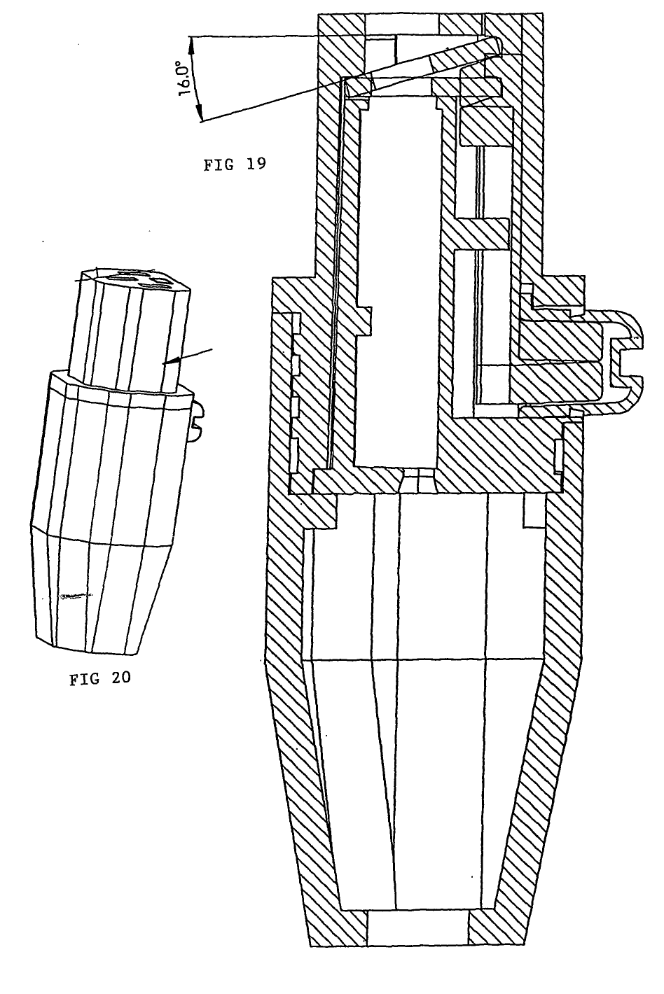

FIG. 19 is a schematic diagram of a further embodiment of the locking connector;

FIG. 20 is a schematic illustration of the outside of one embodiment of the locking connector;

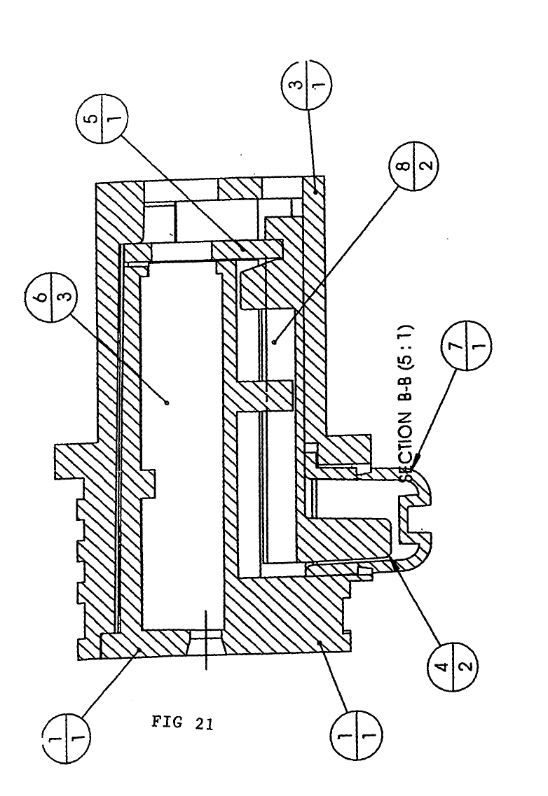

FIG. 21 is a schematic diagram of a further embodiment of the locking connector;

FIG. 22 is a schematic diagram of a further embodiment of the housing of the locking connector;

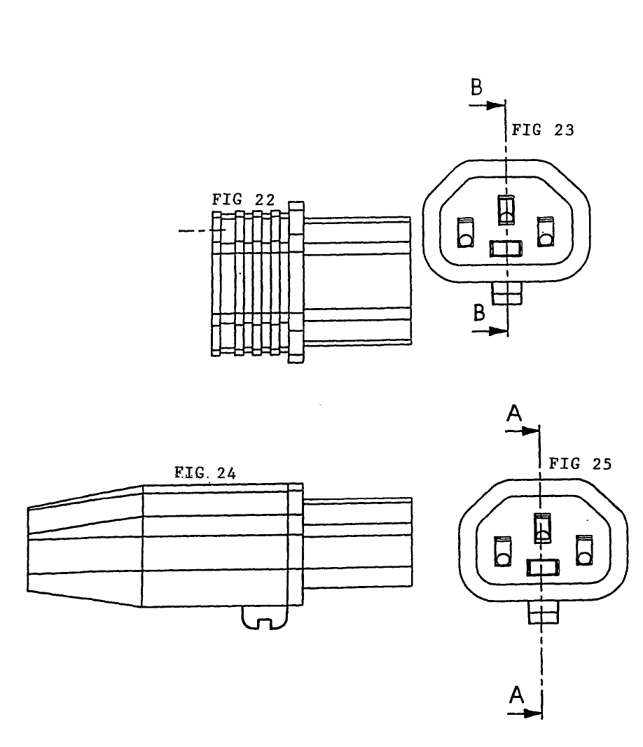

FIG. 23 is a schematic diagram of a further embodiment of the housing of the locking connector;

FIG. 24 is a schematic diagram of a further embodiment of the housing of the locking connector;

FIG. 25 is a schematic diagram of a further embodiment of the housing of the locking connector;

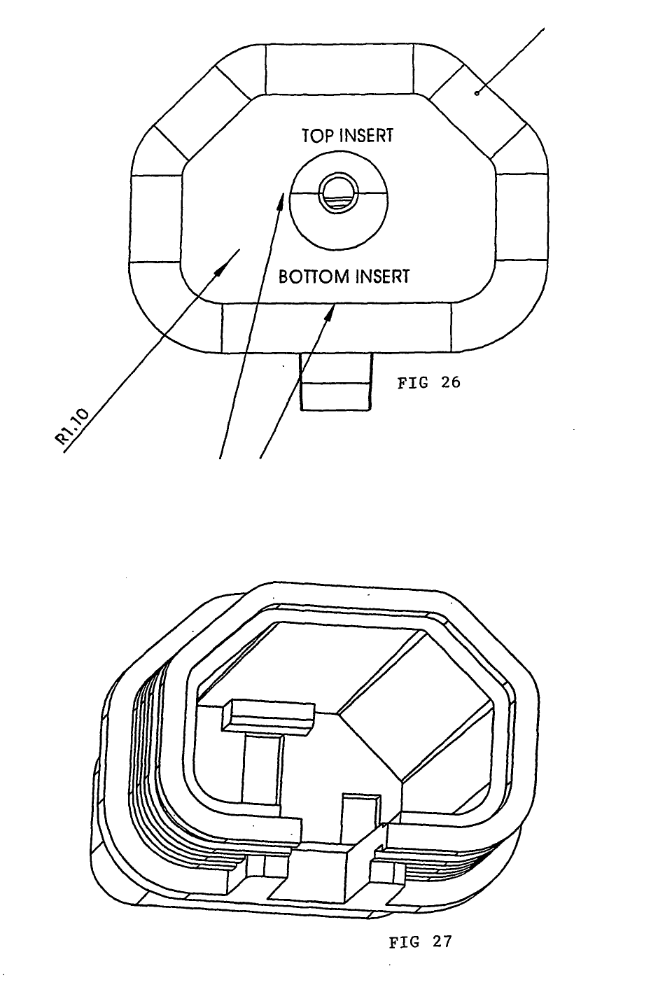

FIG. 26 is a schematic diagram of a further embodiment of the housing of the locking connector;

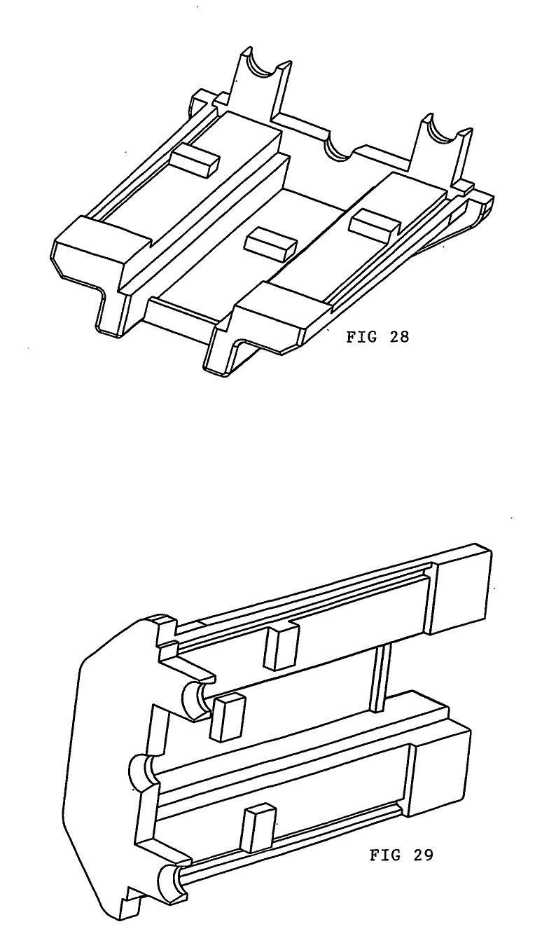

FIG. 27 is a schematic diagram of a further embodiment of the housing of the locking connector;

FIG. 28 is a schematic diagram of a further embodiment of part of the housing of the locking connector;

FIG. 29 is a schematic diagram of a further embodiment of part of the housing of the locking connector;

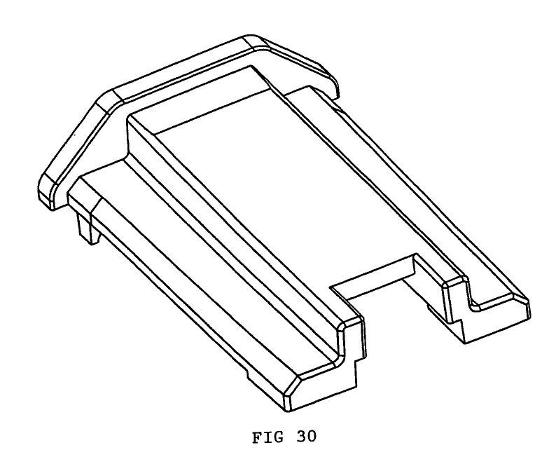

FIG. 30 is a schematic diagram of a further embodiment of part of the housing of the locking connector;

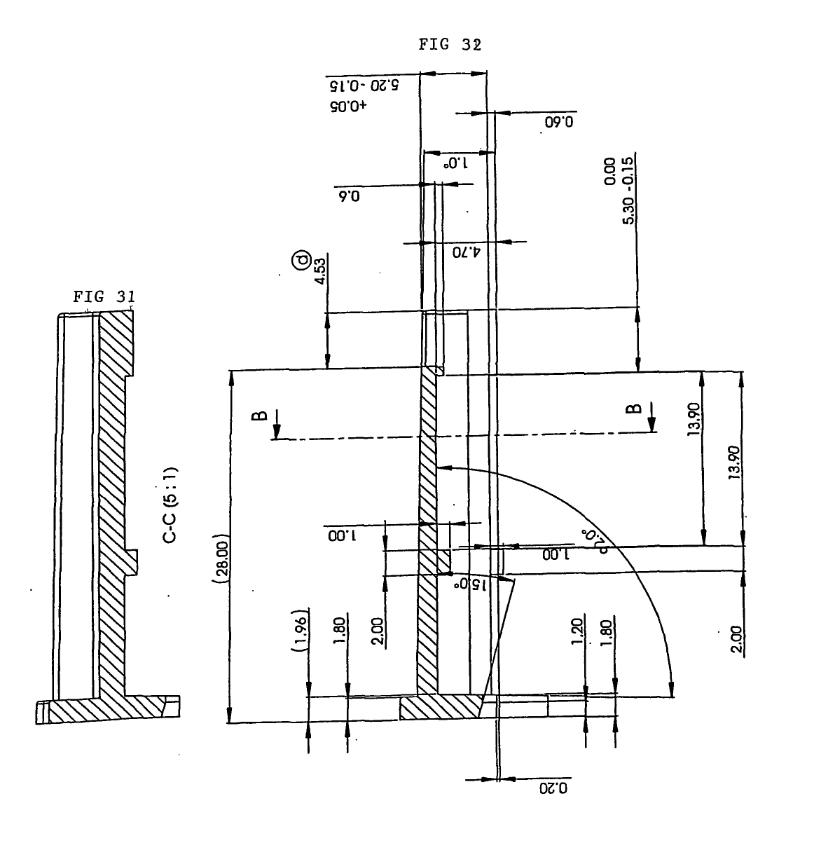

FIG. 31 is a schematic diagram of one embodiment of the slide piece of the locking connector;

FIG. 32 is a schematic diagram of one embodiment of the slide piece of the locking connector;

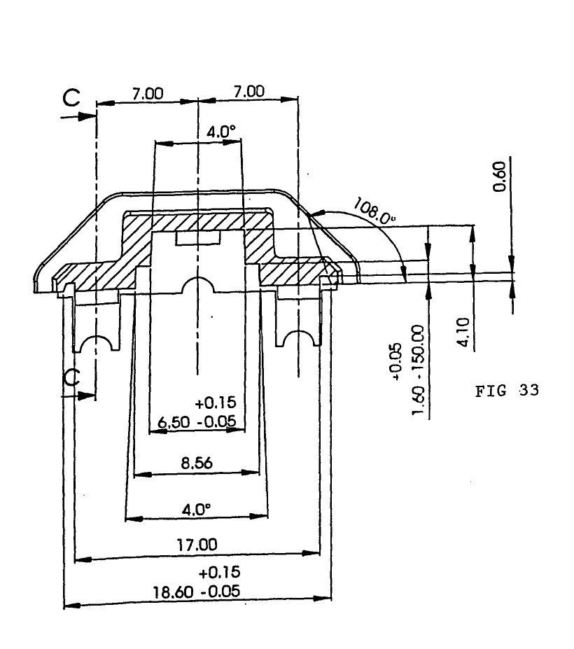

FIG. 33 is a schematic diagram of a further embodiment of part of the locking connector;

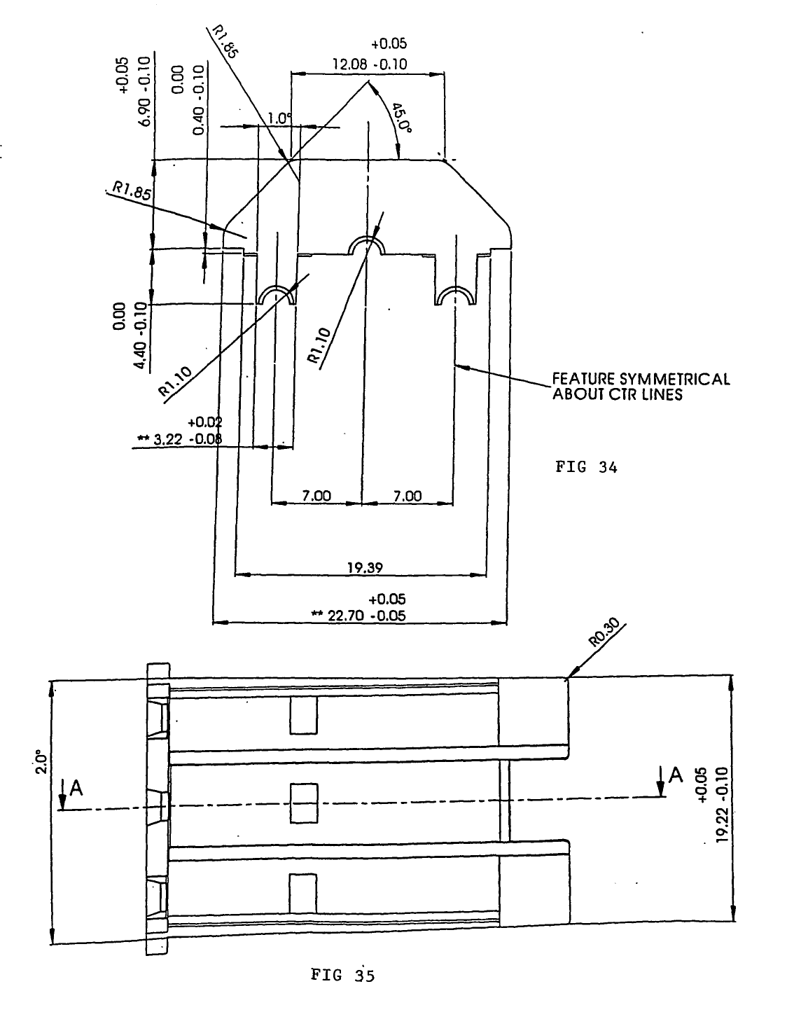

FIG. 34 is a schematic diagram of a further embodiment of part of the locking connector;

FIG. 35 is a schematic diagram of a further embodiment of part of the locking connector;

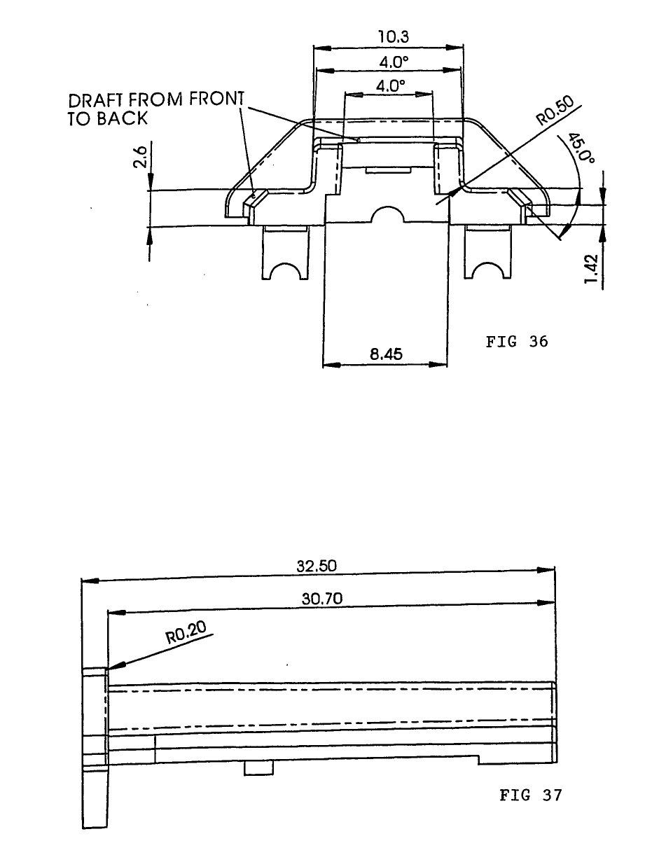

FIG. 36 is a schematic diagram of a further embodiment of part of the locking connector;

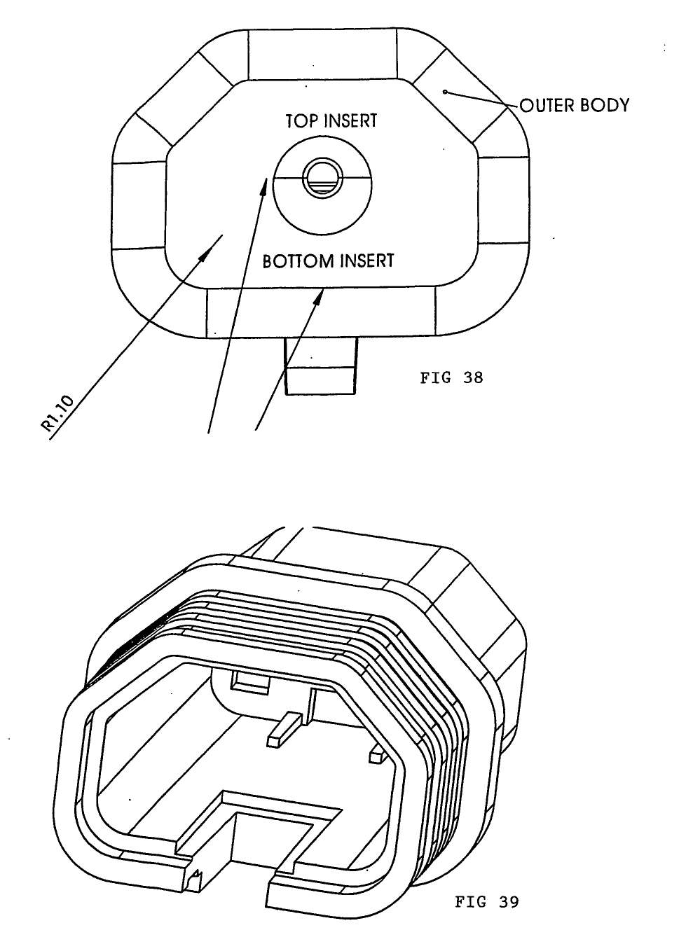

FIG. 37 is a schematic diagram of a further embodiment of part of the locking connector;

FIG. 38 is a schematic diagram of a further embodiment of part of the housing of the locking connector;

FIG. 39 is a schematic diagram of a further embodiment of part of the housing of the locking connector;

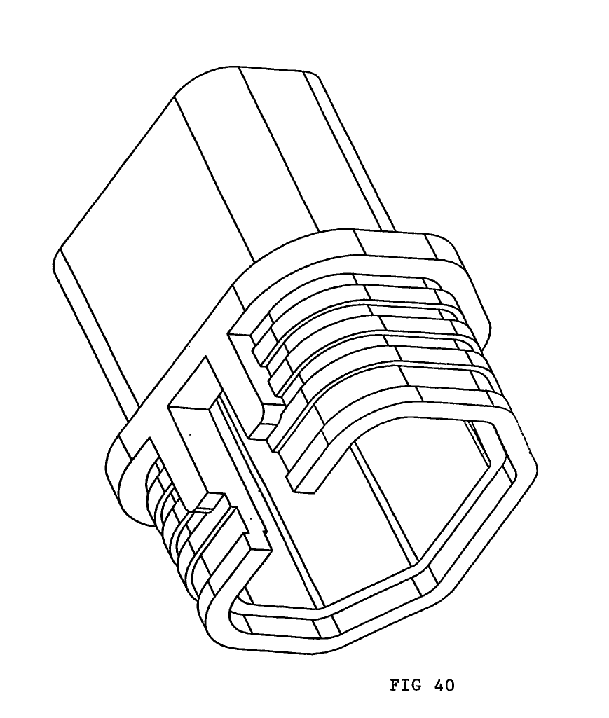

FIG. 40 is a schematic diagram of a further embodiment of part of the housing of the locking connector;

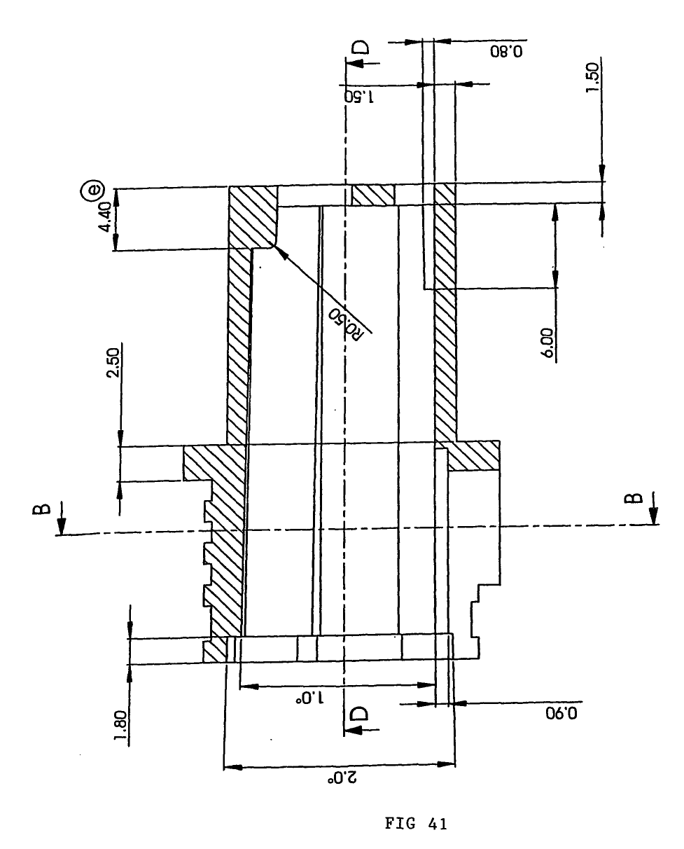

FIG. 41 is a schematic diagram of a further embodiment of part of the housing of the locking connector;

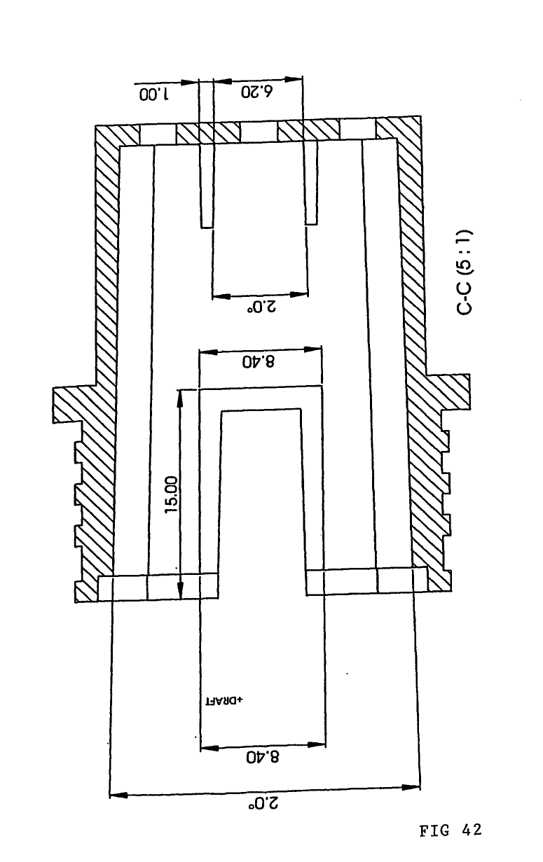

FIG. 42 is a schematic diagram of a further embodiment of part of the housing of the locking connector;

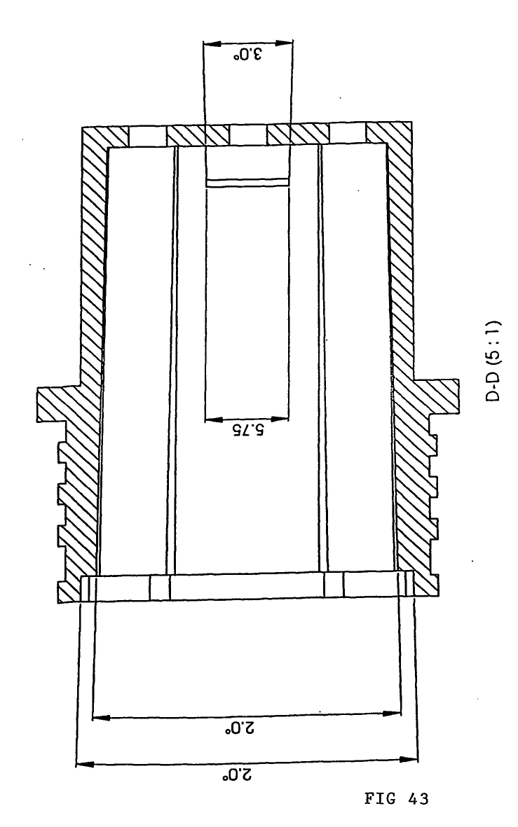

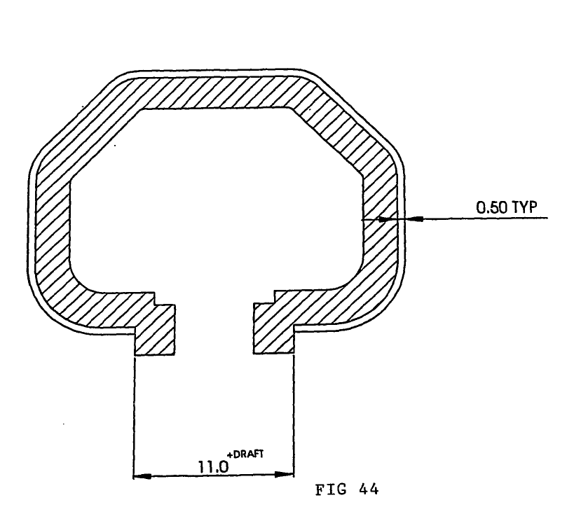

FIG. 43 is a schematic diagram of a further embodiment of part of the housing of the locking connector;

FIG. 44 is a schematic diagram of a further embodiment of part of the housing of the locking connector;

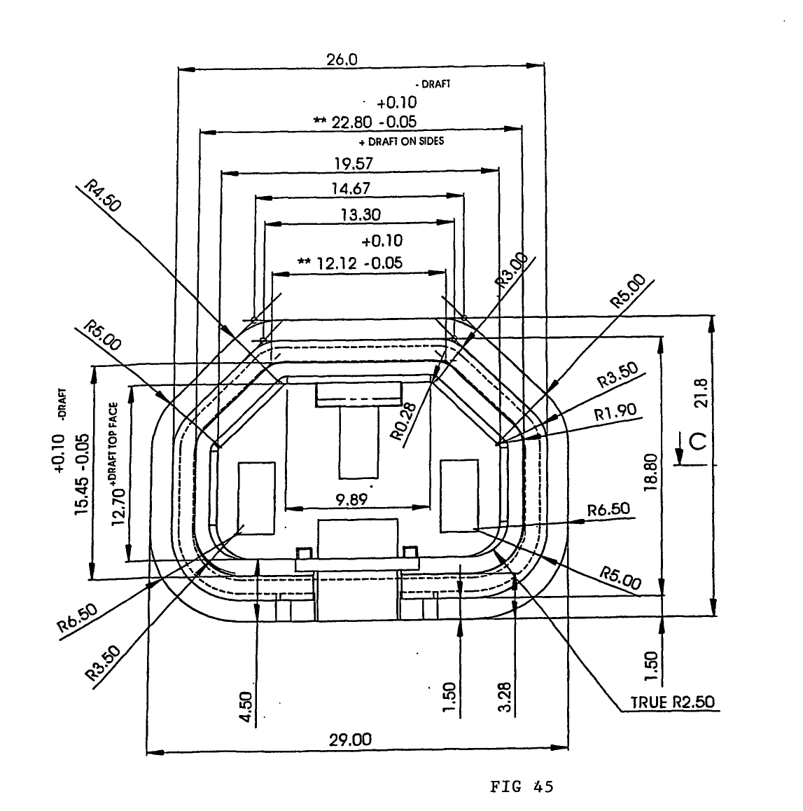

FIG. 45 is a schematic diagram of a further embodiment of the front face of the housing of the locking connector;

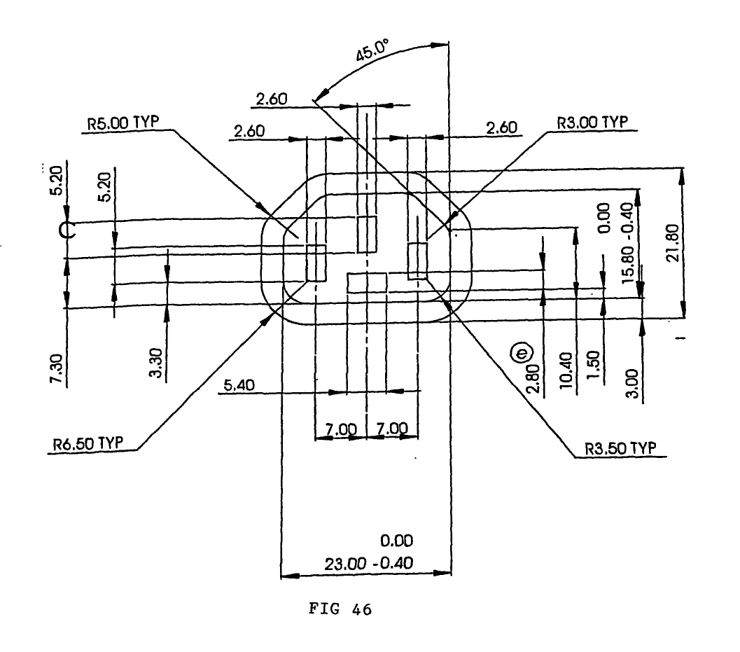

FIG. 46 is a schematic diagram of a further embodiment of the front face of the housing of the locking connector;

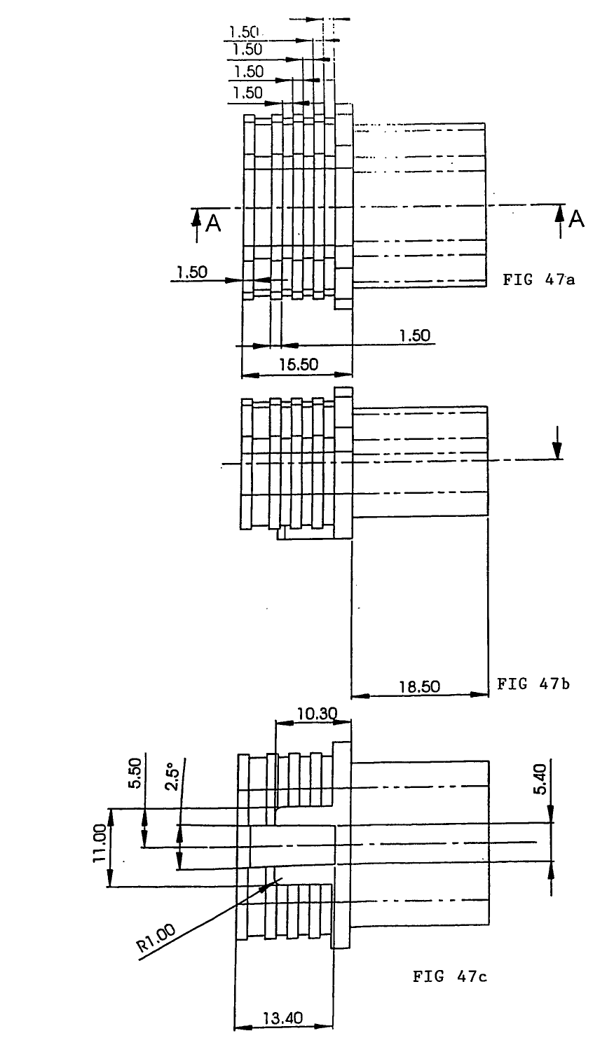

FIGS. 47a, 47b and 47c are top, side and bottom views of a further embodiment of the housing of the locking connector;

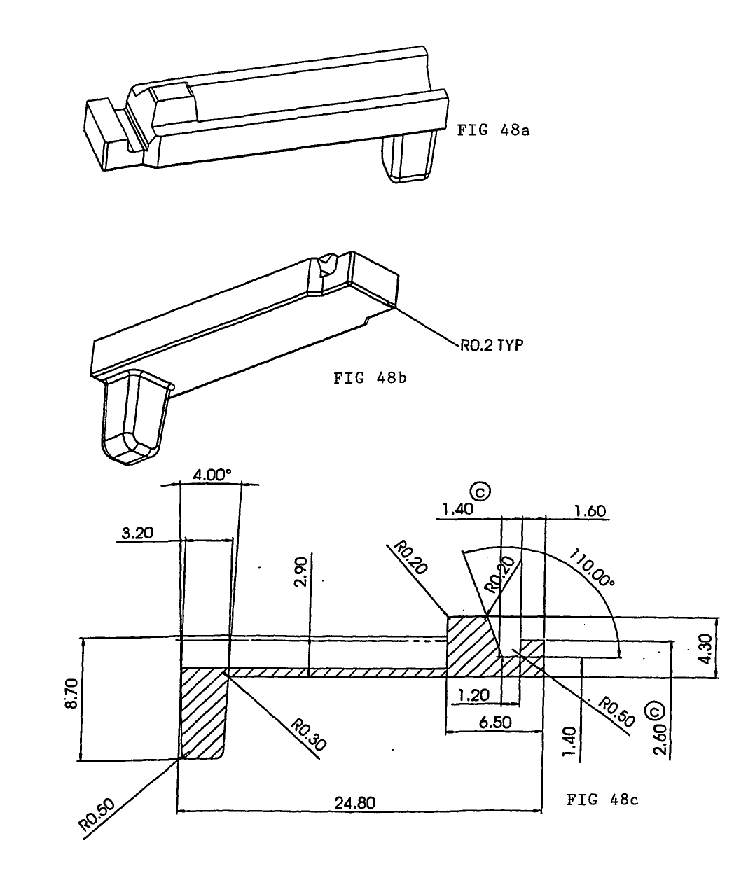

FIGS. 48a, 48b and 48c are schematic views of one embodiment of the slide piece of the locking connector;

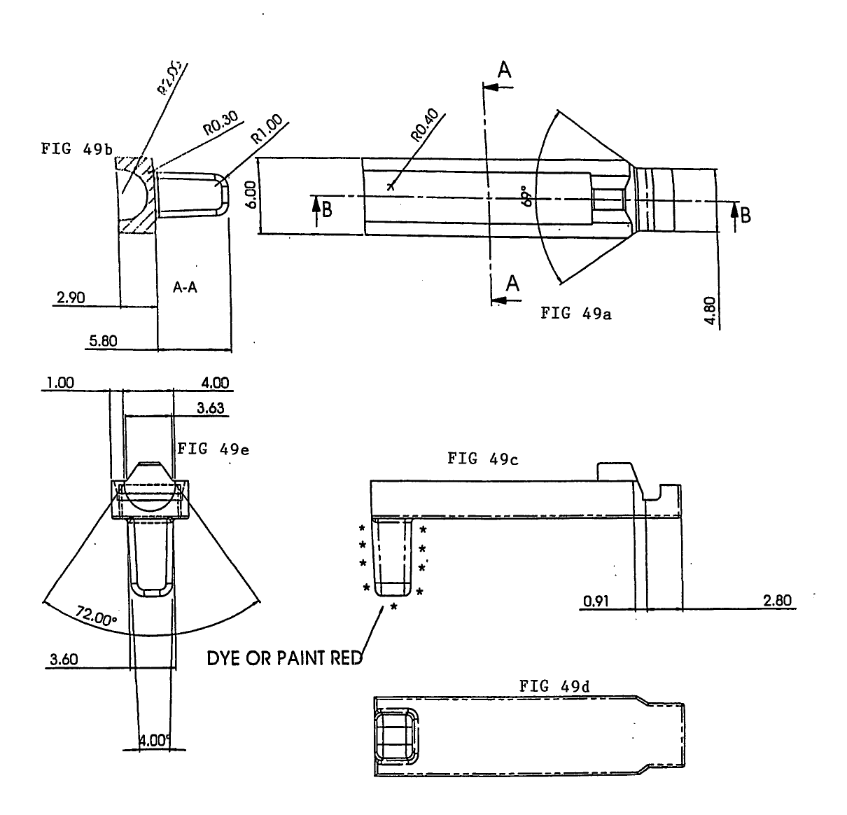

FIGS. 49a, 49b, 49c, 49d and 49e are schematic views of a further embodiment of the slide piece of the locking connector;

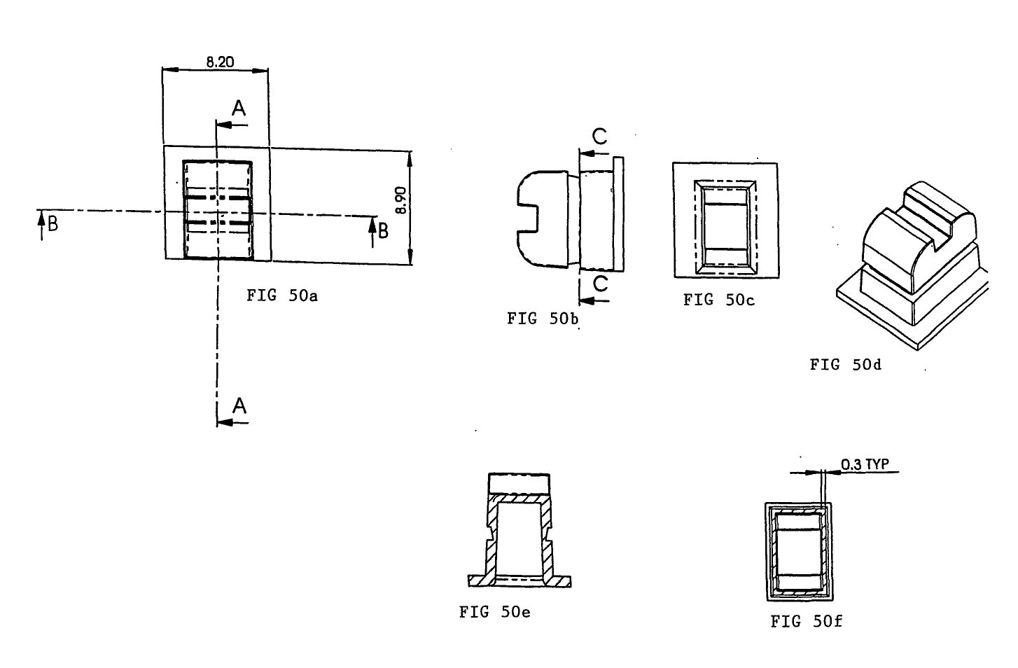

FIGS. 50a, 50b, 50c, 50d, 50e and 50f are schematic views of embodiments of a removable cover for the locking connector described herein;

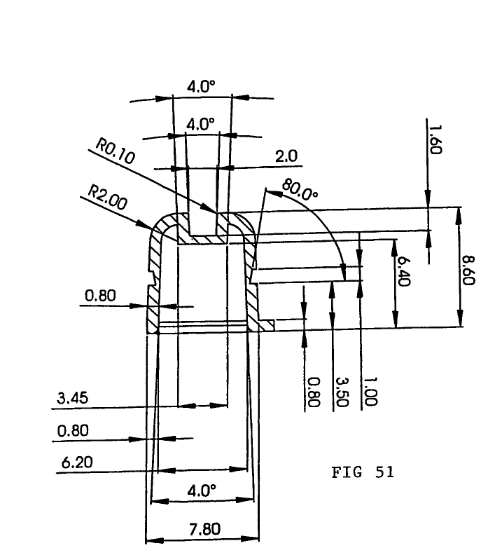

FIG. 51 is an illustration of an embodiment of a removable cover for the locking connector described herein;

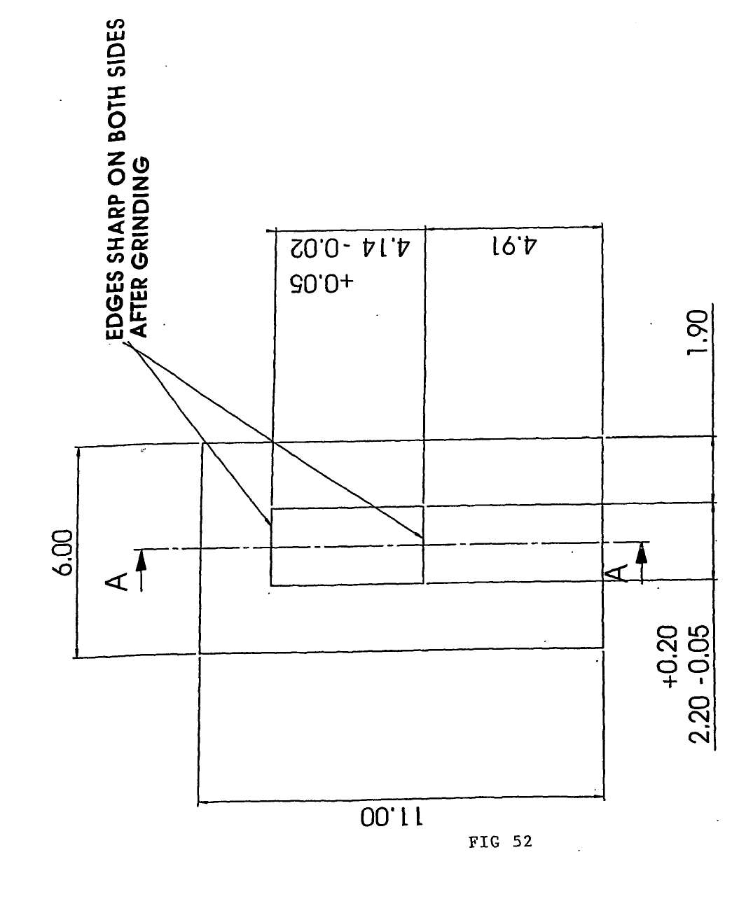

FIG. 52 is a schematic diagram of one embodiment of a latch plate for use in the locking connector described herein;

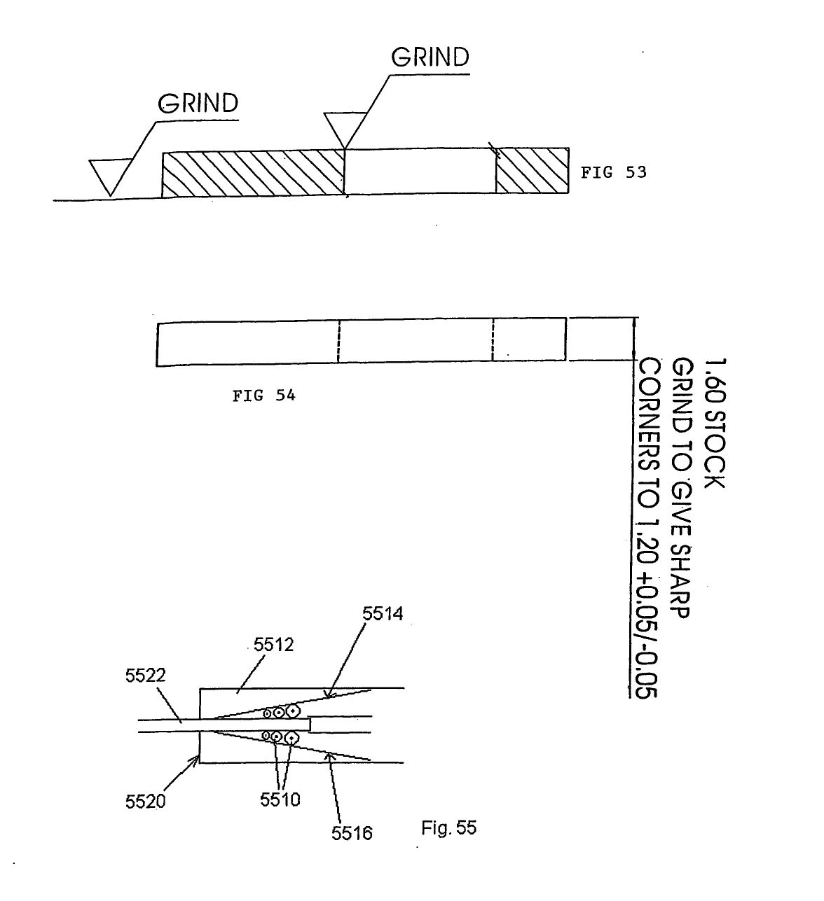

FIG. 53 is a schematic diagram of one embodiment of a latch plate for use in the locking connector described herein;

FIG. 54 is a schematic diagram of one embodiment of a latch plate for use in the locking connector described herein;

FIG. 55 is a schematic diagram of one embodiment of an alternative locking mechanism for use in the locking connector described herein.

The description of one embodiment of the locking connector which follows illustrates one embodiment of the present invention and does not limit the scope of the claims which follow.

One embodiment of the present invention will be described with reference to FIG. 1. The main components of this embodiment are: a locking mechanism provided principally by a latch plate 12 and a spring 14, electrical contacts 28a, 28b, 28c and the body of the connector.

In this embodiment, the body of the connector comprises four main sections of insulating material, e.g. plastics material; the top insert 22, the bottom insert 26, the front connector body 20 and the back connector body 24. The top insert 22 and the bottom insert 26 provide support for the locking mechanism within the body of the connector, holding the components in their correct relative positions. The back connector body 24 and the front connector body 20 join (in the middle of the connector) to form an outer casing around the mechanism of the locking connector. They act to protect the locking mechanism from external interference and also provide an insulating barrier between the electrical components of the mechanism and the user. In this embodiment, the front face 32 of the front connector body 20 contains three holes positioned such that the pins of the plug (not shown) may be inserted through them.

In this embodiment, the housing is manufactured from a number of component parts, which may then be attached, for example by clips or screws. According to an alternative embodiment, the housing may be moulded in one piece around the locking components. If the housing is moulded around the locking mechanism, for example by rear over-mould, then a contact module should provide a complete seal against the potting over-mould material, in particular to still enable free movement of the sprung slide piece.

Before describing the locking mechanism in detail, it is noted that the embodiment has electrical contacts 28a, 28b, 28c, which provide an electrical connection between the (here three) pins inserted into the socket and an electricity supply, or another piece of electrical equipment. A cable (not shown) can be attached in a conventional way (by screw terminals, soldering, crimping) and can emerge from the back end of the back connector body 24.

Alternatively, the socket may be arranged for fixing directly to a printed circuit board or the like. The electrical contacts 28a, 28b, 28c are illustrated schematically in FIG. 1, but the details may be conventional and will not be described or shown in detail.

In this embodiment, the locking mechanism uses latch plate 12, comprising an elongate member containing a hole, to seize a pin of the plug. The latch plate 12 is placed behind the front face of the front connector body 20 so that the hole in the latch plate 34 lines up with one of the holes in the front face 32 of the front connector body 20. In this embodiment, the hole in the latch plate 34 lines up with the middle hole in the front face 32 of the front connector body 20, so that the central earth pin of a plug pushed into the socket is engaged by the locking mechanism. The hole in the latch plate 34 has approximately the same dimensions as the hole in the front face 32 of the front connector body 20, with which it is aligned. In this embodiment, the hole in the latch plate 34 is just large enough to allow a pin to pass through it while the plate is parallel to the connector end face (approximately vertical as shown) so the pin is inserted into the hole at an angle approximately perpendicular to the plane of the latch plate 12. The retaining force produced by the connector is applied to the pin 30 as a frictional force by the edges of the hole in the latch plate 34.

In this embodiment, the top end of the latch plate 12 is held at a single point in the body of the connector between the front connector body 20 and the top insert 22. The other end of the latch plate 12 is biased away from the vertical position shown by a spring. In this case, this end is attached to a slide piece 10 by an arrangement which permits pivoting. The slide piece 10 is an elongate member which, in this embodiment, is positioned perpendicular to the latch plate 12, and generally parallel to the axis of elongation of the connector body. One end of the slide piece 10 is arranged to abut against the front face 32 of the front connector body 20 to retain the slide piece in the body, but the slide piece 10 is able to move over a short distance to a position further back within the connector body. The slide piece 10 is biased towards the front face by the spring 14.

The dimensions of the latch plate depend on the type of pin to which it is designed to attach. In one embodiment, the mechanism is incorporated into an IEC “kettle plug” and the latch plate has a maximum length of around 15 mm and a maximum width of around 10 mm. According to the present embodiment, the latch plate makes an angle of between about 10 degrees and 25 degrees, preferably around 16 degrees, with the front face of the connector when it is in the biased position. Alternative dimensions and angles may be used for different types of locking connectors.

In this embodiment, the spring 14 is a coil spring which is positioned with its compressible axis lying above and parallel to the slide piece 10. One end of the spring 14 bears on the slide piece 10 at a protrusion and the other end of the spring bears on a portion of the bottom insert and so bears against the body of the connector. The slide piece 10 is thus biased towards a position in which it is resting against the front face 32 of the front connector body 20.

As described above, one end of the slide piece 10 bears on one end of the latch plate 12 via an arrangement which permits pivoting. Since the top of the latch plate 12 bears against the connector body and the bottom of the latch plate 12 bears on the slide piece 10, movement of the slide piece 10 has the effect of tilting the latch plate 12 (so that it rotates about a horizontal axis as shown). The latch plate 12 can tilt through a range of angles from substantially parallel with the front face 32 with the spring 14 compressed to an inclined position (in which the hole would not permit movement of a pin therethrough) when the pin is less compressed. Thus the latch plate 12 is biased to seize a pin. This situation is illustrated in FIG. 4, wherein the slide piece 10 and latch plate 12 are shown in the positions towards which they are biased.

Further features of one embodiment of the locking connector are outlined below and illustrated in FIGS. 3 and 4:
The unused volume below the earth contact may be utilised to house the slide piece 10 and spring 14 of this embodiment
The volume in front of the earth contact may be used to house the latch plate 12.

The operation of one embodiment of the locking connector mechanism will now be described in further detail with reference to FIGS. 3 and 4.

FIG. 4 illustrates one embodiment of the locking connector with no pin inserted into the mechanism. As discussed above, the spring 14 provides a biasing mechanism to hold the slide piece 10 against the front face of the connector. The latch plate 12 also rests in its biased position; at an angle to the front face of the connector.

With the latch plate 12 at an angle, the hole within the latch plate 12 presents a smaller area to a pin inserted through the front face of the mechanism than it would if the latch plate 12 was upright. In this embodiment, the hole in the latch plate 12 is designed to be of a size such that it will only allow entry of a pin which is presented substantially perpendicular to the front face of the latch plate 12. As a pin is inserted into the mechanism, therefore, it cannot immediately enter through the hole in the latch plate 12, despite being aligned with that hole. However, the pressure on the latch plate 12, due to attempted insertion of the pin, pushes the bottom of the latch plate 12 away from the front face 32 of the front connector body 20, tilting the latch plate while moving the slide piece 10 towards the back of the device and so compressing the spring 14. When the latch plate 12 has tilted sufficiently, the pin can enter the connector through the hole in the latch plate 12 and the plug can be fully inserted. A schematic overview of the connector with a pin 30 inserted is shown in FIG. 3.

In FIG. 3 it can be seen that, in this embodiment, with the pin 30 inserted into the connector, the pin 30 is approximately perpendicular to the latch plate 12. The spring 14 is held under compression and applies a force, via the slide piece 10, directed towards the front of the connector which biases the latch plate 12 towards its tilted position. This causes the edges of the hole in the latch plate 34 to grip the surfaces of the inserted pin 30.

FIGS. 5a and 5b show a side view of the pin 30 inserted into the latch plate 12a, 12b, which is biased towards a tilted position in each case. As described above, the edges of the hole in the latch plate grip the surfaces of the inserted pin. FIG. 5a illustrates the case in which the latch plate 12a is thick (for example, having a thickness greater than 1 mm). In this case, the pin is gripped by the front corner 36b of the latch plate 12a at the bottom of the hole, and by the back corner 36a of the latch plate 12a at the top of the hole. The arrangement of FIG. 5a may provide a stronger retaining force than that of FIG. 5b, which illustrates the use of a thin latch plate 12b (which may have a thickness of approximately 0.5 mm). In this case, the pin 30 is gripped only at the points where the edges of the hole 38a, 38b in the latch plate 12b meet the pin 30.

Returning to the description of FIG. 3, if a translational force is applied to the pin 30 to remove it from the locking connector, then, since the pin 30 is being gripped by the latch plate 12, and the top of the latch plate 12 cannot move out of the connector, the bottom of the latch plate 12 will tend to be pulled forward towards the front face 32 of the front connector body 20, causing the latch plate 12 to attempt to rotate further about its horizontal axis towards a tilted position. As the latch plate 12 attempts to rotate, however, the edges of the hole in the latch plate 12 grip the inserted pin 30 more tightly. Thus, the larger the force applied to remove the pin 30 from the locking connector, the tighter the latch plate 12 grips the inserted pin 30. This will typically prevent removal of the pin 30, allowing it to be locked permanently into the socket. However, if the latch plate has smoothed edges (or is deformable), the pin may be gripped but it may be possible to pull it out with sufficient force; this may be useful in some cases to inhibit accidental separation of the plug and socket.

To allow optimal operation of the locking mechanism, at least some of the following factors may be considered in its design:
the best start angle of the latch plate
the thickness of the latch plate
the comparative size of the rectangular gripping hole and the cross-section of the pin
the minimum operating angle of the latch plate
to allow for operation in the volume constraints of the distance between the front of the connector and the latch plate, taking into account the latch plate movement and the operation of the sprung actuator.
the spring force required, which may be selected to maximise grip but also to allow for ease of operation and minimising damage to the connector pin.

Some of the factors outlined above may be interrelated, for example it may be helpful to consider the thickness of the latch plate, the size of the hole and the optimum starting and operating angles in conjunction. FIG. 10 shows the inter-relation between the operating angle and the plate thickness, pin height and slot width. Embodiments may be made with variations in the values calculated and chosen for the relevant parameters and the optimum values may depend on further factors such as the type of connector and the material of manufacture of the latch plate. In addition, the locking mechanism and the latch plate in particular should be designed allowing for manufacturing tolerances. In general, it is found that a suitable angle for the latch plate is between about 10 and 20 degrees, typically around 16 degrees.

In some embodiments, particularly when it is desirable for the pin to be removeable, the locking connector may be designed so that it does not lock fully and hence does not risk damaging the pins and equipment. For example, a connector may be designed with a controlled pull out force for mobile equipment where the connector is removed on a regular basis. A further feature may be that the connector will pull out under an excessive load. In this embodiment, a stronger spring may be used and the edges of the hole in the latch plate may not be hardened or sharpened. Hence, there will still be resistance to withdrawal of the pin, but the pin is less likely to be damaged by the mechanism.

With sharp edges, the plate will dig in and then further movement will cause it to dig in further and only a light spring force is necessary to cause initial engagement reliably (the spring force may even be omitted in some cases). With smoother edges, the frictional forces, dependent on the spring force, the angle of the plate and the materials used, restrain the pin. The frictional forces supplement the spring force in causing retention on attempted withdrawal.

In some situations, it may be desirable to allow release of the plug from the socket. One way of allowing removal of the pin from the socket may be to incorporate a release mechanism into the device. This mechanism may take a variety of forms, depending on how easily it is desired to operate. In one possible embodiment, a release button or slide, coupled to a protrusion on the slide piece 10, may be accessible from the outside of the body of the connector. This may be provided when accidental removal is to be avoided but security against unauthorised removal is not of concern, for example to provide kick-proof leads which may be useful in open-plan office environments.

In the present embodiment, however, it is necessary to insert a screwdriver, or a key, into a recess in the body of the connector to move the slide piece and release the mechanism. In alternative embodiments, a release mechanism preferably operates by forcing the latch plate into an upright position, which may be achieved by applying a torque to the latch plate itself or by applying a force to translate the plate or the slide piece horizontally towards the rear of the connector. The connector may incorporate tell-tale means to indicate when the locking connector has been released, such as a plastic tab, which is broken off by the release of the connector. In the present case, insertion of a screwdriver may be through a weakened portion of the connector body, rather than a recess, so the connector is permanently deformed (by piercing of the weakened portion or knock-out) to indicate release.

FIGS. 12a and 12b show one embodiment of the locking connector with a plastic cover 120, which may be made of transparent plastic, over the release mechanism. An object, such as a coin or a screwdriver, may then be inserted into the indentation 122 and a torsional force applied to remove the cover by snapping it at weakened points. The release mechanism may be brightly coloured so that it can be seen clearly through the transparent plastic cover. In an alternative embodiment, the plastic cover itself may be brightly coloured. The removable plastic cover allows access to the release mechanism when necessary, but also provides tell-tale means to indicate to the controller of the apparatus to which the connector is attached that the release means has been accessed. During manufacture of the connector, the transparent window may be inserted into the connector body prior to over-moulding.

FIG. 4 further shows a connector with a test release mechanism that is not operable during normal use of the connector. In this embodiment, the slide piece 10 is operable through a hole 13 in the front face 32 of the front connector body. The hole 13 is also illustrated in FIG. 2. Further embodiments may allow operation of the release mechanism by allowing access to the mechanism from other surfaces of the connector body which are hidden during normal use of the connector. The hole 13 illustrated in FIGS. 2 and 4 further provides increased support for the slide piece 10.

The hidden release mechanism may allow the testing of each connector or a sample of connectors during the manufacturing process. A test rig may be provided to ensure that the connector operates effectively. The test rig would preferably be designed to allow access to the release mechanism and may comprise a complementary connector with a test release pin arranged to mate with the hole in the front face of the connector to operate the release mechanism and release the pin from the connector.

Although the construction described with a slide piece is robust, and facilitates release of the connector if desired, the slide piece may be omitted and the spring may bear directly on the latch plate. The latch plate may incorporate an integral spring, for example if made of spring steel.

The dimensions of the apparatus depend upon the pin to be held by the device, but in this, advantageous, embodiment, the device is incorporated into a standard IEC, or “kettle-plug”, connector for use in connecting together items of electrical equipment. This allows the connector to be applied to a wide range of equipment without any modifications being made to the equipment itself.

A suitable material for the device would again depend on the pin that was being retained but, for many purposes, a material suitable for the latch plate and the slide piece might be a relatively hard metal such as brass or steel, but aluminium or copper or plastics material may also be used.

The latch plate may be manufactured from mild steel, which may be machined and may further be finished by hand. According to a further embodiment, however, the steel latch plate, or blade, may be manufactured from spring steel. According to a preferred embodiment, the steel used is sufficiently hard to maintain sharp edges to the hole in the latch plate. The latch plate may be manufactured using hardened gauge plate and spark erosion or may be manufactured using punching, laser cutting, sintering or MIM. This may allow an accurate rectangular grip hole to be produced with sharp edges. According to an alternative embodiment, the plate may be punched out and then the edges of the hole in the latch plate may be hardened and ground to produce sharp edges. The latch plate may alternatively be manufactured from case hardened mild steel, which may be laser-cut to produce sharp edges to the hole in the latch plate.

The body of the device may be manufactured of an insulating material such as plastics or rubber although, in some situations, it may be desirable to use a material such as metal to provide a body more resistant to external interference. A metal case would preferably be earthed and electrically isolated from the electrical connectors and wires within it. The electrical connectors can be manufactured of any electrically conducting material, such as copper or brass.

In one embodiment, the housing for the connector is manufactured in two pieces, a front piece and a back piece as described above. In this embodiment, the latch plate and the spring actuator may be fitted into the front piece of the housing during manufacture and held in place by a dummy connector pin. The remaining components of the connector may then be assembled and the back piece of the connector housing may be attached, for example clipped, to the front piece. A test release, as described above, may then be used to release the dummy connector pin from the mechanism. A cable grip may further be added to the back piece of the connector housing.

The mechanism of the locking connector and in particular the geometry of the latch plate is preferably arranged to comply with standards in respect of electrical equipment, in particular International Standard EN60320-1. In particular, the connector should be designed to take account of the pin standard limits for vertical width and the minimum contact distance to the earth pin. A stepped mating path may be provided to allow for over a 3 mm gap between the latch plate and the live pin. The live and neutral contacts are preferably set back to allow for contact with the earth pin prior to mating with the live pins. The geometry may further be changed to suit fitting a standard contact assembly.

For sockets into which more than one pin is inserted, the locking connector mechanism may be applied to just one, or to a plurality of pins inserted into the socket.

It should be noted that, although the connector of the embodiment may seize a pin on a complementary connector, the connector is not limited in type or gender—it may be a plug (male) or socket (female) or a “hermaphrodite” or symmetrical connector (having pins and sockets) and is not limited to any particular number of pins, application or size. Nonetheless, particular advantage is provided in a mains power connector in which an earthing pin is seized.

FIGS. 13a to 13e, 14a to 14f, 15a to 15e, 16a to 16h and 17a to 17d show a schematic diagrams of embodiments of a test rig which may be used to optimise the components of the locking connector and for testing latch plates.

FIG. 18 shows one embodiment of a manufactured test rig. The casing of the locking connector in the test rig may be separated into component pieces, preferably a top piece and a bottom piece as shown, to allow easy removal and replacement of the latch plate. The test rig is designed to allow the components of the connector casing to be fixed together securely whilst testing takes place, in this embodiment by using wing nuts. Hence different designs of the components of the locking connector may be tested to produce the most effective connector.

In particular, designs for different latch plates may be investigated. For example, the optimum thickness and material for the latch plate as well as the optimum angle at which to place the plate may be found.

A range of pin sizes may also be tested in the connector to ensure that the operation of the connector will be unaffected by pins that vary from the standard pin size for which the connector is designed and, in particular, to test standard deviations in pin size against the blade quality.

The test rig preferably allows access to a release mechanism for the connector. Preferably, the test rig has a facility for releasing the connector using a slot in the lower front face of the connector and a push bar to release. This may allow the pin to be released from the connector test rig quickly and without disassembling the connector test rig.

According to a further embodiment, a mechanism similar to a rolling clutch may be used to prevent or resist removal of the pin from the connector. FIG. 55 is a schematic diagram of one embodiment of a rolling clutch which may be used in an embodiment of a locking connector 5512. The rolling clutch may comprise a number of rolling elements 5510 which may be, for example cylindrical or spherical elements. The rolling elements are preferably free to move in the direction of insertion of the pin, i.e. away from the front face of the locking connector 5520. Hence, on insertion of the pin 5522, the rollers move away from the front face of the connector, creating a gap between the rollers into which the pin may be inserted. When a user attempts to remove the pin, the rollers bunch and jam against each other and against the inside surfaces of the locking connector body 5514, 5516 and apply a frictional force to the surfaces of the pin 5522, hence resisting or preventing its removal from the connector.

The roller clutch, or other similar mechanism described herein, may be implemented in a variety of ways that will be obvious to one skilled in the art and the description and figure shown herein are not intended to be limiting in any way. Features of other embodiments of the invention described above may be applied to the present embodiment. In particular, the mechanism may be incorporated into a standard IEC socket and a release mechanism may be provided to release the pin from the locking connector mechanism.

The locking connector has many possible applications. One example of a situation in which the locking connector may be used is to lock timing devices to equipment such as computer monitors or televisions, to limit the amount of time the equipment may be used each day. In another embodiment, connecting equipment together using locking connectors may act as a deterrent to thieves.

All copyright and design right in the accompanying drawings is reserved.

1-36. (canceled)

37. A connector comprising a socket for receiving a plug having a plurality of pins wherein the socket presents a greater resistance to withdrawal of at least one pin than to insertion of the pin.

38. A connector according to claim 37 wherein the socket presents a greater resistance to withdrawal of at least one pin by applying frictional forces to the pin.

39. A connector according to claim 37 wherein removal of the pin from the connector is substantially prevented.

40. A connector according to claim 37 further comprising a moveable member which is displaced by insertion of the pin to permit insertion of the pin, but which seizes the pin on attempted withdrawal.

41. A connector according to claim 40 wherein the moveable member comprises a plate having a hole through which the pin is inserted.

42. A connector according to claim 41 wherein the dimensions of the hole in the plate are substantially the same as those of a cross section of a portion of the pin.

43. A connector according to claim 40 wherein the moveable member is biased towards an angled position by a biasing means.

44. A connector according to claim 41 wherein at least one edge of the hole in the moveable member engages and retains the pin by frictional forces.

45. A connector according to claim 41 wherein the front of the plate has a first angular edge at one side of the hole and the back of the plate has a second angular edge at the opposite side of the hole, the first and second edges being arranged to bite into the pin when the plate is angled.

46. A connector according to claim 41 wherein the edges of the hole in the moveable member are processed or hardened to produce substantially sharp edges.

47. A connector according to claim 41 wherein the plate is at least 0.5 mm thick.

48. A connector according to claim 41 wherein the plate is at least 1 mm thick.

49. A connector according to claim 43 wherein the biased moveable member is biased towards a position wherein the moveable member makes an angle of between about 10 degrees and about 20 degrees with the front face of the connector, preferably between about 14 and 18 degrees.

50. A connector according to claim 43 wherein the biased moveable member is arranged to move away from its biased position on insertion of the pin.

51. A connector according to claim 43 wherein the biasing means comprises a spring.

52. A connector according to claim 51 wherein the spring is a coil spring.

53. A connector according to claim 51 wherein the spring is a leaf spring.

54. A connector according to claim 51 wherein the spring applies a torque to the biased moveable member.

55. A connector according to claim 37 wherein the resistance to withdrawal of the pin is provided by a plurality of moveable members constrained by a tapered cavity.

56. A connector according to claim 37 further comprising means for releasing the pin from the retaining mechanism.

57. A connector according to claim 56 wherein the means for releasing the pin comprises a mechanism to reduce the magnitude of the forces applied to the pin by the moveable member.

58. A connector according to claim 56 wherein the means for releasing the pin comprises a sliding bar for releasing the pin by applying a force to counteract the biasing force.

59. A connector according to claim 56 wherein the means for releasing the pin is not accessible during normal use.

60. A connector according to claim 56 wherein the means for releasing the pin is accessible via a removable cover.

61. A connector according to claim 56 wherein the means for releasing the pin is accessible on or adjacent to the front face of the connector.

62. A connector according to claim 56 having:
means for releasing the pin during testing, wherein the means is accessible on or adjacent to the front face of the connector;
means for releasing the pin accessible via a removable cover.

63. A connector according to claim 56 wherein the means for releasing the pin further comprise tell-tale means to indicate whether the release mechanism has been used.

64. A connector according to claim 63 wherein the tell-tale means comprises a removable cover attached over the release means.

65. A connector according to claim 37 wherein the pin is the earth pin of a plug.

66. A connector according to claim 65 wherein the connector is arranged such that the locking components of the connector are electrically isolated from the live electrical supply components.

67. A connector according to claim 37 wherein the connector is incorporated into a IEC socket.

68. A device for supplying controlled power to a further device, the device being provided with a connector according to claim 37 for connecting to the further device.

69. A process for manufacturing a latch plate for use in a locking connector according to claim 37 comprising:
punching the latch plate out of spring steel, the latch plate having a hole through which a pin may be inserted;
hardening the spring steel at the edges of the hole in the latch plate;
grinding the edges of the hole in the latch plate to produce substantially sharp edges.

70. A method according to claim 71 further comprising barrelling on a zinc coating.

71. A test rig comprising:
a connector according to claim 37;
a complementary connector comprising means for releasing the pin from the connector.

72. A test rig according to claim 71 wherein the complementary connector releases the pin from the connector by operating a test release mechanism on or adjacent to the front face of the connector.

73. A connector comprising a socket for receiving a plug having a plurality of pins wherein the socket presents a greater resistance to withdrawal of at least one pin than to insertion of the pin by frictional forces applied to the pin.
